(19) United States
(12) Patent Application Publication
(10) Pub. No.: US 2012/0113776 A1
(43) Pub. Date: May 10, 2012

(54) SPOT POSITION CONTROL DEVICE AND SPOT POSITION CONTROL METHOD

(75) Inventors: Junichi Horigome, Tokyo (JP); Yoshihiko Deoka, Tokyo (JP)

(73) Assignee: Sony Corporation, Tokyo (JP)

(21) Appl. No.: 13/288,605

(22) Filed: Nov. 3, 2011

(30) Foreign Application Priority Data
Nov. 10, 2010 (JP) 2010-251574

(51) Int. Cl. G11B 7/08

(52) U.S. Cl. 369/44.14; G9B/7.041

(57) ABSTRACT

A spot position control device includes a light irradiation and light sensing unit irradiating an optical recording medium with first light via an objective lens and sensing reflection light of the first light from the optical recording medium having a pit string where an interval between pit formable positions on one round is limited to a first interval, a tracking mechanism unit displacing the objective lens, a clock generation unit generating a clock corresponding to the interval between the pit formable positions, a timing selector signal generation unit generating a plurality of timing selector signals, a tracking error signal generation unit generating tracking error signals, a linear tracking error signal generation unit generating a linear tracking error signal indicating a tracking error amount linearly, a tracking servo control unit performing a tracking servo control, and an offset giving unit giving an offset to a tracking servo loop.

### BACKGROUND

The present disclosure relates to a spot position control device and a spot position control method, which control a spot position of light applied to an optical recording medium via an objective lens.

As optical recording media for recording and reproducing signals using light irradiation, so-called optical discs such as, for example, a CD (Compact Disc), a DVD (Digital Versatile Disc), a BD (Blu-ray Disc: registered trademark), and the like have become prevalent.

In the optical disc such as the CD, the DVD, and the BD, for example, as shown in FIG. 28A, a plurality of tracks (pit strings or grooves) are formed in the radius direction. A so-called track jumping operation where a spot jumps between the tracks arranged in the radius direction is performed.

Here, in a case where, as the track jumping operation, a movement to a predetermined track is performed from a state where a tracking servo is performed for a certain track as a target, first, the tracking servo is turned off and an objective lens is driven based on a predetermined jumping pulse, thereby moving the spot Sp to a target track. Next, a braking pulse is given at a predetermined timing so as to reduce the movement velocity of the spot Sp, and then the tracking servo is turned on, thereby performing a pull-in servo for the target track.

Japanese Unexamined Patent Application Publication No. 2004-158187 is an example of related art.

### SUMMARY

As described above, in the optical disc system in the related art, when a spot position is moved in the radius direction by one or more tracks as the track jumping operation, the tracking servo is temporarily turned off. This is because, as shown in FIG. 28B, aliasing occurs in the tracking error signal waveform due to the movement of the spot Sp from the track which is a servo target by a half track.

As described above, since the tracking servo is temporarily turned off, there are problems in the optical disc system in the related art, such as a case where it is necessary to perform the pull-in as described above again, or a complicated control for smoothly performing the pull-in is necessary when the track jumping is performed.

It is desirable to generate a tracking error signal which expresses a tracking error amount from a track which is a servo target linearly without generating the above-described aliasing.

According to an embodiment of the present disclosure, there is provided a spot position control device including a light irradiation and light sensing unit, a tracking mechanism unit, a clock generation unit, a timing selector signal generation unit, a tracking error signal generation unit, a linear tracking error signal generation unit, a tracking servo control unit, and an offset giving unit.

The light irradiation and light sensing unit irradiates an optical recording medium with first light via an objective lens and senses reflection light of the first light from the optical recording medium having a pit string where an interval between pit formable positions on one round is limited to a first interval and which is formed in a spiral shape or a concentric shape and is arranged in a radius direction, where the interval between the pit formable positions in a pit string formation direction is set to be misaligned by a predetermined second interval such that the optical recording medium has a plurality of pit string phases.

The tracking mechanism unit displaces the objective lens in the radius direction.

The clock generation unit generates a clock corresponding to the interval between the pit formable positions based on a light sensing signal obtained by the light irradiation and light sensing unit sensing reflection light of the first light.

The timing selector signal generation unit generates a plurality of timing selector signals which respectively indicate timings for the pit formable positions on the pit strings having the respective phases, formed on the optical recording medium, based on the clock generated by the clock generation unit.

The tracking error signal generation unit that generates a plurality of tracking error signals which respectively indicate tracking errors in the pit strings having the respective phases, formed on the optical recording medium, based on the light sensing signal for the reflection light of the first light and the timing selector signals generated by the timing selector signal generation unit.

The linear tracking error signal generation unit that generates a linear tracking error signal expressing a tracking error amount linearly, by sequentially connecting signals in sections around zero-cross points of the plurality of tracking error signals obtained when an irradiation spot of the first light is moved in the radius direction.

The tracking servo control unit that performs a tracking servo control for the objective lens by driving the tracking mechanism based on the linear tracking error signal.

The offset giving unit that gives an offset for moving the irradiation spot in the radius direction to a tracking servo loop formed by the tracking servo control by the tracking servo control unit.

According to the structure of the optical recording medium having the pit string according to the embodiment of the present disclosure, the pit strings can be arranged in the radius direction so as to exceed the optical limit. In addition, since the pit strings are arranged in the radius direction so as to exceed the optical limit in this way, tracking error signals for the pit strings having the respective phases can be obtained simultaneously and in parallel by the tracking error signal generation unit.

At this time, in a state where the irradiation spot of the first light is moved in the radius direction, as each of the tracking error signals, a signal having a phase difference corresponding to a phase difference of the pit string can be obtained, for example, as shown in FIG. 18.

Here, if the spot position is forced to be moved in the radius direction, for example, for track jumping, in a state where a tracking servo is performed for a certain pit string, a level of a tracking error signal for the servo target pit string is gradually varied from a zero level to a polarity side according to the movement direction of the spot. In addition, if a movement amount of the spot reaches a specific amount or more, aliasing occurs in the error signal as described above.

Therefore, in the embodiment of the present disclosure, by obtaining error signals for the pit strings having the respective phases simultaneously and in parallel, and connecting signals around zero-cross points of the tracking error signals for the pit strings having the respective phases, a linear tracking error signal which can express even a large tracking error amount causing aliasing in the related art, linearly, is generated.

In this case, by performing a tracking servo control based on the linear tracking error signal, it is possible to prevent the tracking servo from being deviated even if the movement amount is large enough to cause aliasing in the tracking error signal in the related art when a spot position is forced to be moved in the radius direction for track jumping by giving an offset to a servo loop. In other words, it is possible to maintain a state of performing the tracking servo.

That is to say, as a result, it is possible to realize a control of moving a spot position in a movement amount of one or more track widths, such as, for example, track jumping, through the closed-loop control.

As described above, according to the embodiments of the present disclosure, it is possible to generate a linear tracking error signal which can express a tracking error amount linearly even in a case where a movement amount of a spot is large to an extent that aliasing occurs in a tracking error signal in the related art.

In addition, according to the embodiments of the present disclosure, by performing a tracking servo control based on the linear tracking error signal, a spot position control where it is necessary to move a spot position by a movement amount causing aliasing in the related art, such as the track jumping, can be realized through a closed-loop control.

### BRIEF DESCRIPTION OF THE DRAWINGS

FIG. 1 is a diagram illustrating a bulk recording method.

FIG. 2 is a cross-sectional structure view of a bulk type recording medium which is a target of recording and reproduction according to the related example and an embodiment.

FIG. 3 is a diagram illustrating a method of recording and reproducing marks on and from the bulk type recording medium.

FIG. 4 is a diagram mainly illustrating a configuration of an optical system included in a spot position control device according to the related example and the embodiment.

FIG. 5 is a partially enlarged plan view of a surface of the reference face of the bulk type recording medium according to the related example and the embodiment.

FIG. 6 is a diagram illustrating a form where pits are formed on the entire reference face.

FIGS. 7A to 7C are diagrams illustrating a format of address information.

FIG. 8 is a schematic diagram illustrating a relationship between a form where a spot of servo laser light is moved on the reference face through rotation driving of the bulk type recording medium, and waveforms of a sum signal, a sum differential signal, and a PP (push-pull) signal which are obtained at this time.

FIG. 9 is a diagram illustrating a detailed method of detecting a peak position.

FIG. 10 is a schematic diagram illustrating a relationship between clocks generated from a timing signal indicating a peak timing, and a waveform of each selector signal generated based on the clocks and each pit string (or a part thereof) formed on the reference face.

FIGS. 11A and 11B are diagrams illustrating light sensing spot misalignment of reflection light due to tilt or lens shift.

FIG. 12 is a diagram illustrating a generation method of a tracking error signal according to the related example.

FIG. 13 is a block diagram illustrating the overall internal configuration of a spot position control device according to the related example.

FIG. 14 is a diagram illustrating an internal configuration of a clock generation circuit.

FIG. 15 is a diagram illustrating an internal configuration of a selector signal generation and selection unit included in the spot position control device according to the related example.

FIG. 16 is a diagram illustrating a detailed spot position control method for realizing a spot movement through a closed-loop control according to the related example.

FIG. 17 is a diagram illustrating the spot position control method according to the related example by correlation with tracking error signals for the respective pit strings.

FIG. 18 is a diagram illustrating a spot position control method according to the embodiment.

FIG. 19 is a diagram illustrating a generation method of a linear tracking error signal.

FIG. 20 is a diagram illustrating an internal configuration of a spot position control device according to the embodiment.

FIG. 21 is a diagram illustrating an internal configuration of a tracking error signal generation unit included in the spot position control device according to the embodiment.

FIG. 22 is a waveform diagram of each tracking error signal obtained when a spot position is moved in the radius direction.

FIGS. 23A and 23B are diagrams illustrating a state where an irradiation spot of laser light traces a predetermined pit string.

FIG. 24 is a waveform diagram of each tracking error signal generated by a generation method of a linear tracking error signal according to a modified example.

FIG. 25 is a diagram illustrating the generation method of the linear tracking error signal according to the modified example.

FIG. 26 is a diagram illustrating a cross-sectional structure of an optical recording medium according to the modified example.

FIG. 27 is a diagram illustrating a structure of a reference face according to the modified example.

FIGS. 28A and 28B are diagrams illustrating a track jumping operation and a problem thereof in the optical disc system in the related art.

### DETAILED DESCRIPTION OF EMBODIMENTS

Here, in the present specification, prior to description of embodiments, the related example which is a basis of the present disclosure will be first described.

In addition, the flow of the overall description is as follows.

1. RELATED EXAMPLE

1-1. OPTICAL RECORDING MEDIUM WHICH IS TARGET OF RECORDING AND REPRODUCTION

1-2. CONFIGURATION OF OPTICAL SYSTEM

1-3. STRUCTURE OF REFERENCE FACE

1-4. ADDRESS INFORMATION

1-5. SELECTION METHOD OF SERVO TARGET PIT STRING

1-6. PROBLEM OF METHOD OF SAMPLING PUSH-PULL SIGNAL

1-7. OVERALL INTERNAL CONFIGURATION OF SPOT POSITION CONTROL DEVICE

1-8. DETAILED METHOD FOR REALIZING SPOT MOVEMENT THROUGH CLOSED-LOOP CONTROL

2. EMBODIMENT

2-1. PROBLEM OF RELATED EXAMPLE

2-2. POSITION CONTROL METHOD ACCORDING TO EMBODIMENT

2-3. CONFIGURATION OF SPOT POSITION CONTROL DEVICE ACCORDING TO EMBODIMENT

3. MODIFIED EXAMPLE

### 1. Related Example

### 1-1. Optical Recording Medium which is Target of Recording and Reproduction

Here, as an optical recording medium which is a target of recording and reproduction in embodiments described later including the related example, a so-called bulk recording type optical recording medium (hereinafter, a bulk type recording medium) will be described as an example.

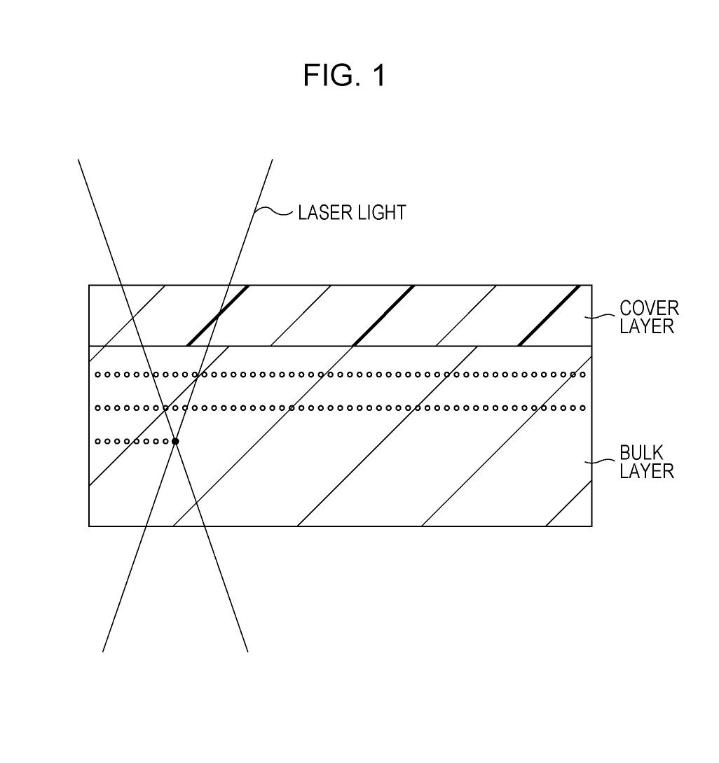

The bulk recording is a technique in which, for example, as shown in FIG. 1, laser light irradiation is performed for an optical recording medium having at least a cover layer and a bulk layer (recording layer) while sequentially changing focal positions and thus multi-layer recording is performed inside the bulk layer, thereby achieving a large recording capacity.

The bulk recording is also disclosed in Japanese Unexamined Patent Application Publication No. 2008-135144 and Japanese Unexamined Patent Application Publication No. 2008-176902.

Specifically, for such bulk recording, a recording technique called a micro hologram type is disclosed in Japanese Unexamined Patent Application Publication No. 2008-135144. In the micro hologram type, a so-called hologram recording material is used as a recording material of the bulk layer. As the hologram recording material, for example, light cured photopolymer or the like is widely used.

The micro hologram type is largely classified into a positive micro hologram type and a negative micro hologram type.

The positive micro hologram type is a method in which two light beams (light beam A and light beam B) opposite to each other are collected at the same position so as to form fine interference fringes (holograms), which are used as recording marks.

In addition, the negative micro hologram type is a method in which, in contrast to the positive micro hologram type, interference fringes which are formed in advance are erased by laser light irradiation, and the erased portions are used as recording marks. In the negative micro hologram type, it is necessary to form interference fringes on the bulk layer in advance as an initialization process.

Further, the present applicant has proposed a recording method of forming voids (blanks, vacancies) as recording marks, as disclosed in, for example, Japanese Unexamined Patent Application Publication No. 2008-176902, as a method of bulk recording different from the micro hologram type.

The void recording method is a method in which laser light irradiation is performed for the bulk layer made of a recording material such as, for example, light cured photopolymer at relatively high power, thereby forming blanks inside the bulk layer. As disclosed in Japanese Unexamined Patent Application Publication No. 2008-176902, the blank portions formed in this way have a refractive index different from other portions in the bulk layer, and thus reflectance of light at the interfaces can be heightened. Therefore, the blank portions function as recording marks, and thereby information recording is realized by the formation of the blank marks.

Since the void recording type does not form holograms, recording may be completed through light irradiation from one side. In other words, it is not necessary to collect two light beams at the same position and form recording marks unlike the positive micro hologram type.

Upon comparison with the negative micro hologram type, there is an advantage in that the initialization process is not necessary.

In addition, although an example where when the void recording is performed, pre-cure light is applied before the recording is described in Japanese Unexamined Patent Application Publication No. 2008-176902, the void recording can be performed even if the application of the pre-cure light is omitted.

However, the recording layer (bulk layer) of the bulk type recording medium where the above-described variety of recording methods are proposed does not have an explicit multi-layer structure in the meaning that, for example, a plurality of position guiders or recording films (reflection films) on which the position guiders are formed. That is to say, steps for forming a plurality of recording films (and position guiders) which a typical multi-layer disc has can be omitted, and thus manufacturing costs are reduced accordingly.

However, in a state of the structure of the bulk type recording medium shown in FIG. 1 described above, a focus servo or a tracking servo may not be performed during the recording where the marks are not formed.

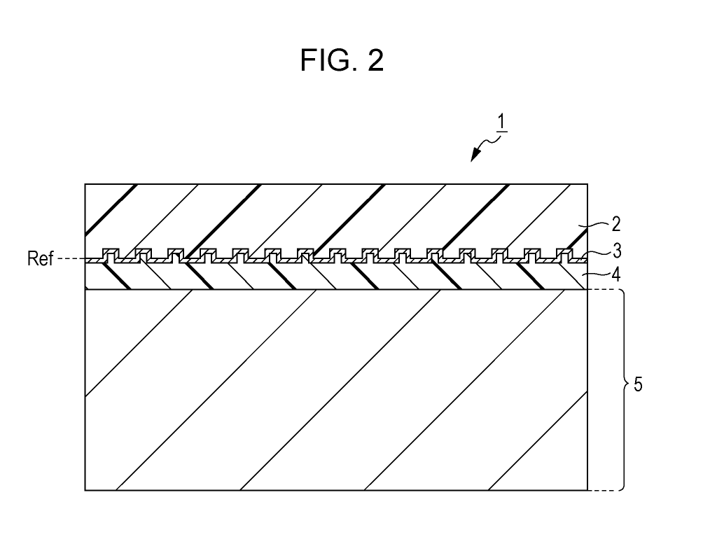

For this reason, in practice, the bulk type recording medium is provided with a reflection face (reference face Ref) which has position guiders as shown in FIG. 2 and is used as a reference. Here, the bulk type recording medium having the reference face is referred to as a bulk type recording medium 1 as shown in FIG. 2.

Here, in the following description, the terms “upper layer side” and “lower layer side” are used, and, in the present specification, the “upper layer side” indicates an upper layer side when a face to which laser light from a spot position control device (a recording and reproduction device 10) described later is incident is an upper face.

In addition, in the following description, the term “depth direction” is used and indicates a direction (that is, a direction parallel to an incident direction of laser light from the device: focus direction) corresponding with the vertical direction according to the definition of the “upper layer side”.

In FIG. 2, in the bulk type recording medium 1, guide grooves (position guiders) accompanied by the formation of pit strings are formed on a lower layer side of a cover layer 2 in a spiral shape or a concentric shape, and a selective reflection film 3 is formed thereon. A bulk layer 5 is formed (adhered) under the lower layer side of the cover layer 2 on which the selective reflection film 3 is formed, via the intermediate layer 4 made of, for example, an adhesive material such as a UV cured resin.

Here, as described later, the above-described pit strings are formed, thereby recording absolute position information (address information) such as, for example, radius position information or rotation angle information. In the following description, the face where the pit strings are formed and the absolute position information is recorded (in this case, a reflection face of the selective reflection film 3) is referred to as a “reference face Ref”.

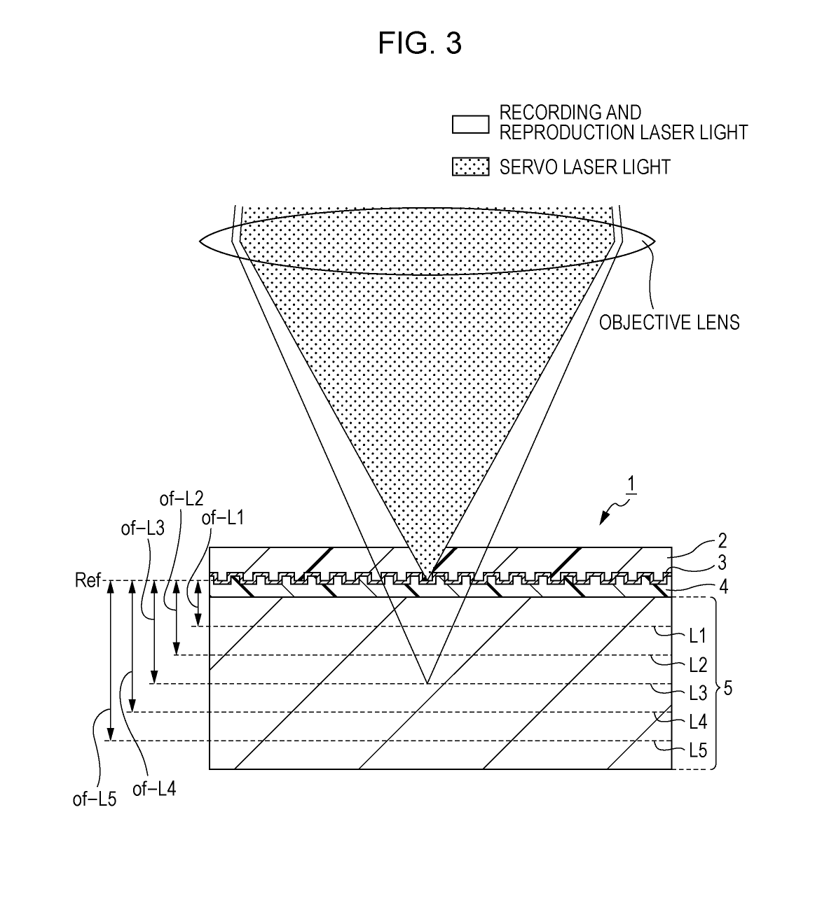

In addition, in the medium structure, laser light for recording (or reproducing) marks (hereinafter, also referred to as recording and reproduction laser light or simply referred to as recording and reproduction light), and servo laser light (simply referred to as servo light) as laser light for position control are applied to the bulk type recording medium 1, as shown in FIG. 3.

As shown in the figure, the recording and reproduction laser light and the servo laser light are applied to the bulk type recording medium 1 via the common objective lens.

At this time, if the servo laser light reaches the bulk layer 5, it may have an adverse effect on the mark recording in the bulk layer 5. For this reason, in the bulk recording method in the related art, the servo laser light and the recording and reproduction laser light use laser light having different wavelength ranges, and the selective reflection film 3 having wavelength selectivity of reflecting the servo laser light and transmitting the recording and reproduction laser light therethrough is provided.

An operation of recording marks on the bulk type recording medium 1 will be described with reference to FIG. 3 on the above-described premise.

First, when multi-layer recording is performed for the bulk layer 5 which does not have guide grooves or a reflection film on which the guide grooves are formed, a layer position where the marks are recorded in the bulk layer 5 in the depth direction is set in advance. In the figure, as a layer position where marks are formed (mark forming layer position: also referred to as an information recording layer position) in the bulk layer 5, a case is exemplified where a total of five information recording layer positions L of a first information recording layer position L1 to a fifth information recording layer position L5. As shown, the first information recording layer position L1 is set at a position separated from the selective reflection film 3 (reference face Ref) on which the guide grooves are formed, in the focus direction (depth direction) by a first offset of-L1. In addition, the second information recording layer position L2, the third information recording layer position L3, the fourth information recording layer position L4, and the fifth information recording layer position L5 are respectively set at positions separated from the reference face Ref by a second offset of-L2, a third offset of-L3, a fourth offset of-L4, and a fifth offset of-L5.

The number of the layer positions L is not limited to five.

Here, the offset of-L information is set in advance in a controller 41 included in a spot position control device (recording and reproduction device 10) as the related example described later (this is also true of a controller 54 according to the embodiment).

During the recording where marks have not been formed yet, a focus servo and a tracking servo may not be performed for each layer position L inside the bulk layer 5 based on reflection light of the recording and reproduction laser light. Therefore, a focus servo control and a tracking servo control of the objective lens during the recording are performed such that a spot position of the servo laser light tracks the guide grooves (pit strings described later) on the reference face Ref based on reflection light of the servo laser light.

However, it is necessary for the recording and reproduction laser light to reach the bulk layer 5 formed at the lower layer side of the reference face Ref for the mark recording. For this reason, an optical system in this case is provided with a focus mechanism (recording and reproduction light focus mechanism) for independently adjusting a focal position of the recording and reproduction laser light separately from the focus mechanism of the objective lens.

Specifically, as the recording and reproduction light focus mechanism, there is provided an expander which varies a collimation state (divergence, parallel, and convergence) of the recording and reproduction laser light incident to the objective lens. That is to say, by varying the collimation state of the recording and reproduction laser light incident to the objective lens in this way, it is possible to adjust a focal position of the recording and reproduction laser light independently from the servo laser light.

The focus mechanism for the recording and reproduction laser light is provided, and thus, as described above, the focus and tracking servo controls of the objective lens are performed based on reflection light of the servo laser light from the reference face Ref. Thereby, a focal position of the recording and reproduction laser light is controlled so as to correspond with a necessary information recording layer position L in the bulk layer 5, and to be located at a position corresponding to the guide groove formed on the reference face Ref in the tracking direction.

In addition, when reproduction is performed for the bulk type recording medium 1 on which marks have already been formed, it is not necessary to control a position of the objective lens based on reflection light of the servo laser light unlike during the recording. In other words, during the reproduction, it is preferable to perform a focus servo control and a tracking servo control of the objective lens based on reflection light of the recording and reproduction laser light by targeting a mark string formed on the information recording layer positions L to be reproduced.

### 1-2. Configuration of Optical System

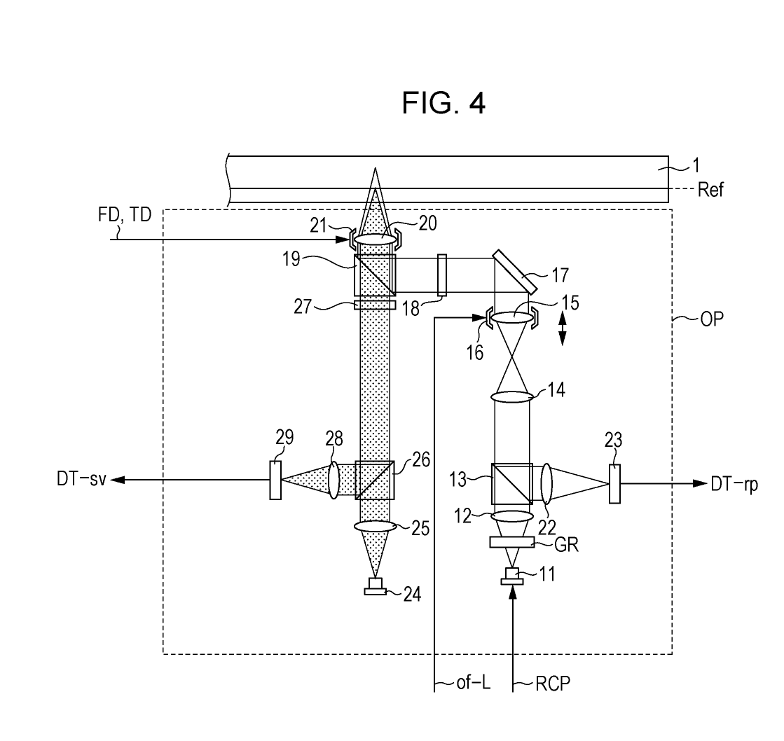

FIG. 4 is a diagram mainly illustrating a configuration of an optical system included in a recording and reproduction device 10 which performs recording and reproduction for the above-described bulk type recording medium 1 according to the related example. Specifically, an internal configuration of an optical pickup OP included in the recording and reproduction device 10 is mainly shown.

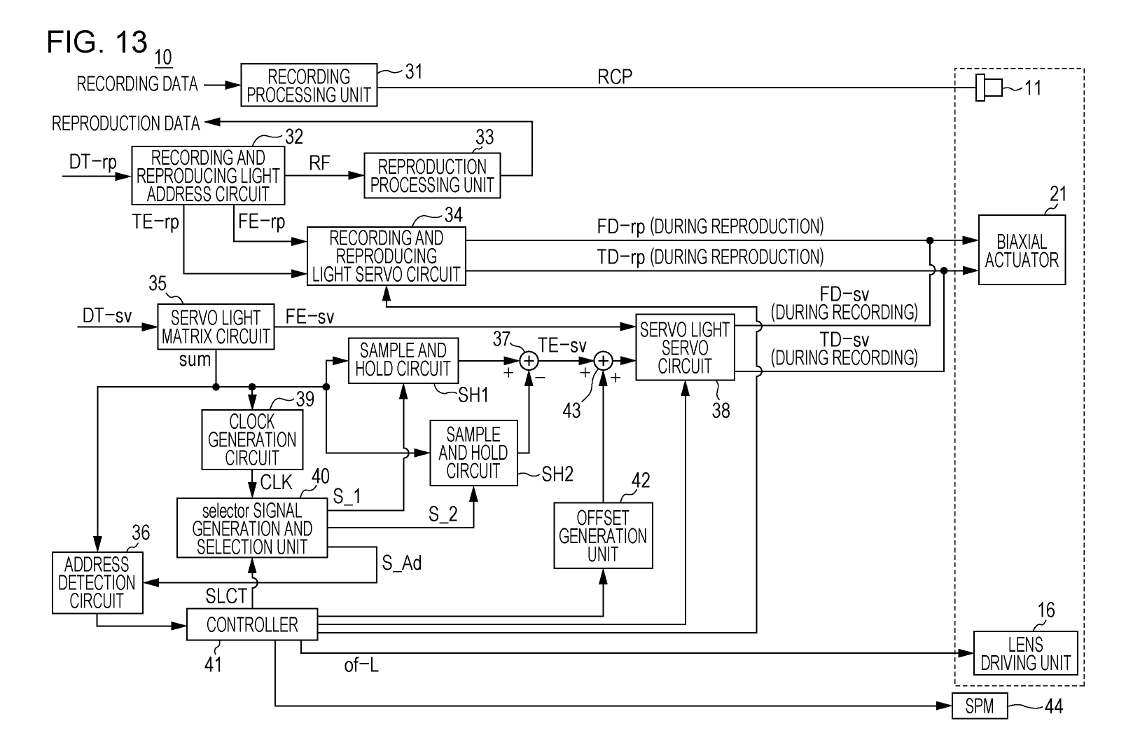

In FIG. 4, the bulk type recording medium 1 loaded onto the recording and reproduction device 10 is set such that the center hole thereof is clamped at a predetermined position in the recording and reproduction device 10, and is held to be rotatably driven by a spindle motor 44 (FIG. 13) which is not shown here.

The optical pickup OP is provided to irradiate the bulk type recording medium 1 which is rotatably driven by the spindle motor 44 with recording and reproduction laser light and servo laser light.

In the optical pickup OP, there are provided a recording and reproduction laser 11 which is a light source of recording and reproduction laser light for recording information by marks, and reproducing the information recorded using the marks, and a servo laser 24 which is a light source of servo laser light for performing a position control using position guiders (pit strings described later) formed on the reference face Ref.

Here, as described above, the recording and reproduction laser light and the servo laser light have different wavelength ranges. In this example, the wavelength of the recording and reproduction laser light is about 405 nm (so-called blue-violet laser light), and the wavelength of the servo laser light is about 650 nm (red laser light).

In addition, in the optical pickup OP, there is provided an objective lens 20 which is an output stage of recording and reproduction laser light and servo laser light to the bulk type recording medium 1.

In addition, there are provided a recording and reproduction light sensing unit 23 for sensing reflection light of the recording and reproduction laser light from the bulk type recording medium 1, and servo light sensing unit 29 for sensing reflection light of the servo laser light from the bulk type recording medium 1.

Further, in the optical pickup OP, there is an optical system which guides recording and reproduction laser light emitted from the recording and reproduction laser 11 to the objective lens 20, and guides reflection light of the recording and reproduction laser light from the bulk type recording medium 1, which is incident to the objective lens 20, to the recording and reproduction light sensing unit 23.

Specifically, the recording and reproduction laser light emitted from the recording and reproduction laser 11 is incident to a polarization beam splitter 13 after becoming parallel light via a collimation lens 12. In this way, the polarization beam splitter 13 is configured to transmit the recording and reproduction laser light incident from the recording and reproduction laser 11 therethrough.

The recording and reproduction laser light passing through the polarization beam splitter 13 is incident to an expander formed by a fixed lens 14, a movable lens 15, and a lens driving unit 16. The expander corresponds to the above-described recording and reproduction light focus mechanism, where the fixed lens 14 is disposed at a side close to the recording and reproducing laser 11 which is a light source and the movable lens 15 is disposed at a side far from the recording and reproducing laser 11, and the movable lens 15 is driven in a direction parallel to the optical axis of the recording and reproduction laser light by the lens driving unit 16, thereby performing an independent focus control for the recording and reproduction laser light.

As described later, the lens driving unit 16 in the recording and reproduction light focus mechanism is driven depending on a value of the offset of-L set according to a target information recording layer position L, by the controller 41 shown in FIG. 13.

The recording and reproduction laser light passing through the fixed lens 14 and the movable lens 15 included in the recording and reproduction light focus mechanism is incident to a dichroic prism 19 via a ¼ wavelength plate 18 after being reflected at a mirror 17 as shown in the figure.

The dichroic prism 19 has a selective reflection surface which reflects light having the same wavelength as the recording and reproduction laser light and transmits light having wavelengths other than that therethrough. Therefore, the recording and reproduction laser light incident as described above is reflected by the dichroic prism 19.

The recording and reproduction laser light reflected by the dichroic prism 19 is applied to the bulk type recording medium 1 via an objective lens 20 as shown in the figure.

The objective lens 20 is provided with a biaxial actuator 21 which holds the objective lens 20 so as to be displaced in the focus direction (direction coming into contact with and separating from the bulk type recording medium 1) and the tracking direction (direction perpendicular to the focus direction: the radius direction of the bulk type recording medium 1).

The biaxial actuator 21 has a focus coil and a tracking coil, which are respectively supplied with driving signals (driving signals FD and TD described later) and displace the objective lens 20 in the focus direction and tracking direction, respectively.

Here, during the reproduction, it is possible to obtain reflection light of the recording and reproduction laser light from the bulk type recording medium 1 (the mark strings recorded on the information recording layer positions L which are targets of the reproduction inside the bulk layer 5) in response to the application of the recording and reproduction laser light to the bulk type recording medium 1 as described above. The reflection light of the recording and reproduction laser light obtained in this way is guided to the dichroic prism 19 via the objective lens 20 and then is reflected by the dichroic prism 19.

The reflection light of the recording and reproduction laser light, which has been reflected by the dichroic prism 19, passes through the ¼ wavelength plate 18, the mirror 17, and the recording and reproduction light focus mechanism (the movable lens 15 to the fixed lens 14), and then is incident to the polarization beam splitter 13.

Here, the polarization direction of the reflection light (returning path light) of the recording and reproduction laser light incident to the polarization beam splitter 13 in this way is different by 90 degrees from that of the recording and reproduction laser light (outgoing path light) incident to the polarization beam splitter 13 from the recording and reproduction laser 11 side, due to an operation of the ¼ wavelength plate 18 and the operation at the time of reflection at the bulk type recording medium 1. As a result, the reflection light of the recording and reproduction laser light incident in this way is reflected by the polarization beam splitter 13.

As such, the reflection light of the recording and reproduction laser light reflected by the polarization beam splitter 13 is collected on a light sensing surface of the recording and reproduction light sensing unit 23 via a condensing lens 22.

Further, in the optical pickup OP, in addition to the configuration of the optical system for the recording and reproduction laser light described above, there is the formation of an optical system which guides servo laser light emitted from the servo laser 24 to the objective lens 20 and guides reflection light of the servo laser light from the bulk type recording medium 1, which has been incident to the objective lens 20, to the servo light sensing unit 29.

As shown in the figure, the servo laser light emitted from the servo laser 24 is incident to a polarization beam splitter 26 after becoming parallel light via a collimation lens 25. The polarization beam splitter 26 is configured to transmit the servo laser light (outgoing path light) incident from the servo laser 24 side therethrough as such.

The servo laser light passing through the polarization beam splitter 26 is incident to the dichroic prism 19 via a ¼ wavelength plate 27.

As described above, the dichroic prism 19 is configured to reflect light having the same wavelength range as the recording and reproduction laser light and transmits light having wavelengths other than that therethrough, and thus the servo laser light passes through the dichroic prism 19 and is applied to the bulk type recording medium 1 via the objective lens 20.

Further, reflection light (reflection light from the reference face Ref) of the servo laser light obtained in response to the application of the servo laser light to the bulk type recording medium 1 passes through the dichroic prism 19 via the objective lens 20, and is incident to the polarization beam splitter 26 via the ¼ wavelength plate 27.

In a manner similar to the case of the recording and reproduction laser light, the polarization direction of the reflection light (returning path light) of the servo laser light incident from the bulk type recording medium 1 in this way is different from that the outgoing path light by 90 degrees, due to an operation of the ¼ wavelength plate 27 and the operation at the time of reflection at the bulk type recording medium 1, and, as a result, the reflection light of the servo laser light as the returning path light is reflected by the polarization beam splitter 26.

The reflection light of the servo laser light reflected by the polarization beam splitter 26 is collected on a light sensing surface of the servo light sensing unit 29 via a condensing lens 28.

Here, although description through illustration is omitted, in practice, the recording and reproduction device 10 is provided with a slide driving unit which slidably drives the overall optical pickup OP described above in the tracking direction, and an irradiation position of laser light can be displaced in a wide range through the driving of the optical pickup OP by the slide driving unit.

### 1-3. Configuration of Reference Face

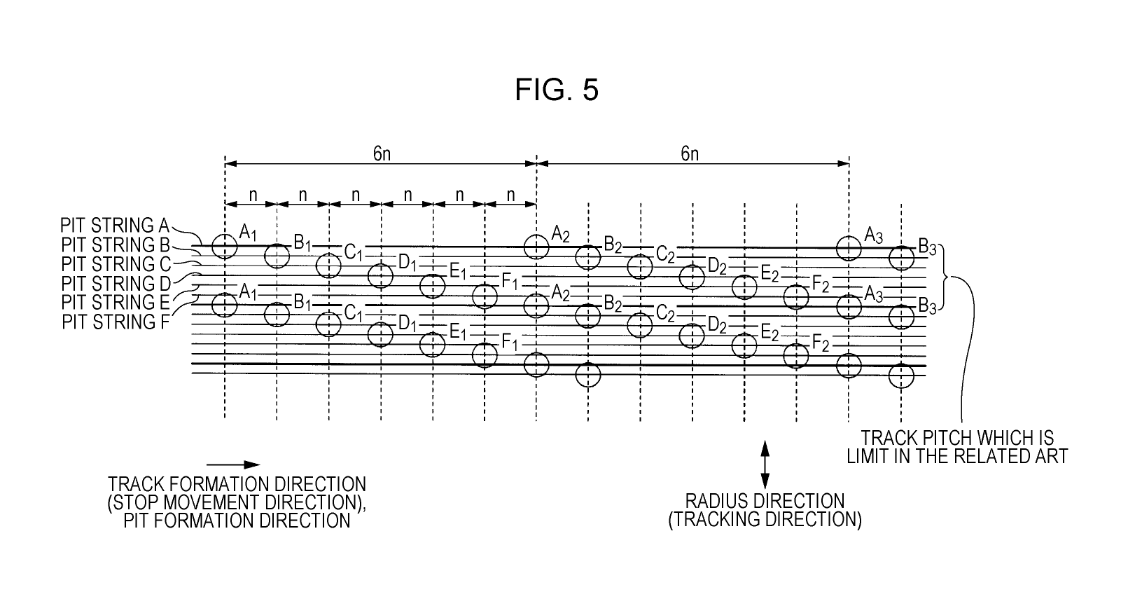

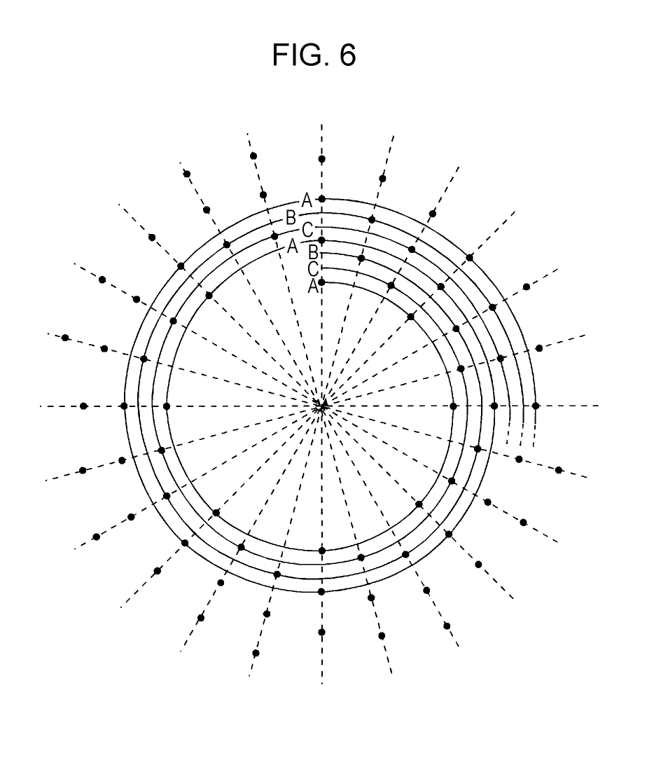

A form where pit strings are formed on the reference face Ref of the bulk type recording medium 1 in this example will be described with reference to FIGS. 5 and 6.

FIG. 5 is a partially enlarged plan view of the surface of the reference face Ref (the selective reflection film 3) in the bulk type recording medium 1.

In FIG. 5, a direction from the left side to the right side of the figure is set to a formation direction of a pit string, and, as a result, a formation direction (line direction) of a track. In this case, it is assumed that an irradiation spot of servo laser light is moved from the left side to the right side of the figure according to the rotation driving of the bulk type recording medium 1.

In addition, a direction (a longitudinal direction of the figure) perpendicular to the formation direction of the pit string is a radius direction of the bulk type recording medium 1.

In addition, in FIG. 5, A to F denoted with the white circles in the figure indicate pit formable positions. That is to say, on the reference face Ref, a pit is formed only at a corresponding pit formable position, and pits are not formed at positions other than the pit formable position.

The distinction between the signs A to F in the figure indicates a distinction between the pit strings (distinction between pit strings arranged in the radius direction), and the numbers added to the signs A to F indicate a distinction between pit formable positions on a pit string.

Here, the interval denoted with the black thick line indicates a minimal track pitch (limit track pitch in the related art) which can be realized in the bulk type recording medium 1 in the related art. As can be seen therefrom, in the bulk type recording medium 1 according to the embodiment, a total of six pit strings of A to F are formed in one track width which is a limit in the related art, that is, are arranged with a pitch exceeding an optical limit in the radius direction.

However, there is concern that positions where pits are formed may overlap each other in the pit string formation direction when a plurality of pit strings are simply arranged in one track width which is a limit in the related art, and, as a result, there is concern that an interval between pits in the pit string formation direction may exceed the optical limit.

Therefore, in this example, the following conditions are defined such that an interval between pits in the pit string formation direction does not exceed the optical limit in a plurality of pit strings A to F arranged in one track width which is a limit in the related art.

That is to say, 1) an interval between the pit formable positions is limited to a predetermined first interval in each of the pit strings A to F.

2) The respective pit strings A to F where an interval between pit formable positions is limited as above are arranged such that pit formable positions are misaligned by a predetermined second interval in the pit string formation direction (phases of the respective pit strings are deviated at the second interval).

Here, an interval (the second interval) between the pit formable positions in the pit string formation direction in the pit strings A to F arranged in the radius direction is set to n. At this time, when the respective pit strings A to F are arranged so as to satisfy the above condition 2), intervals between pit formable positions of the pit string A and B, the pit string B and C, the pit string C and D, the pit string D and E, and the pit string E and F, and the pit string F and A are all n, as shown in the figure.

In addition, an interval (the first interval) between the pit formable positions in each of the pit strings A to F is 6n because this case realizes a total of six pit string phases from A to F.

In this example, information reproduction and servo control using the servo laser light on the reference face Ref are performed under the condition of the wavelength λ=about 650 nm, and the numerical aperture NA=about 0.65 in a manner similar to a case of a DVD (Digital Versatile Disc). In this example, in order to correspond thereto, a section length of each pit formable position is 3 T (where T is a channel bit) which is the same as the shortest mark in the DVD, and an interval between edges of the pit formable position in each of the pit strings A to F in the pit string formation direction is also set to the length of the same 3 T. In other words, according thereto, n becomes 6 T.

As a result, the above conditions 1) and 2) are satisfied.

Here, in order to understand a form where pits are formed on the entire reference face Ref, a more detailed formation method of pit strings will be described with reference to FIG. 6.

In FIG. 6, for convenience of illustration, a case where the kinds (phases) of pit strings are only three of A to C is exemplified.

In addition, in the figure, the black circles indicate pit formable positions.

As can be seen from FIG. 6, on the reference face Ref of the bulk type recording medium 1, a plurality of pit strings having different phases (although three pit strings A to C are shown in FIG. 6, in practice, six pit strings A to F are present) form one set, and one set of a plurality of pit strings is formed in a spiral shape.

Thereby, when a tracking servo is performed for a necessary pit string among the plurality of pit strings, a spot position draws a spiral trajectory.

In addition, pits are formed on the reference face Ref by a CAV (Constant Angular Velocity) method. With this, as shown in the figure, positions where pits are formed (pit formable positions) are arranged at the same angular positions in the radius direction for each of a plurality of pit strings.

Here, if the pits are recorded on the reference face Ref by the CAV method, a phase relationship between the respective pit strings A to F is maintained in any region on a disc as shown in FIG. 5.

### 1-4. Address Information

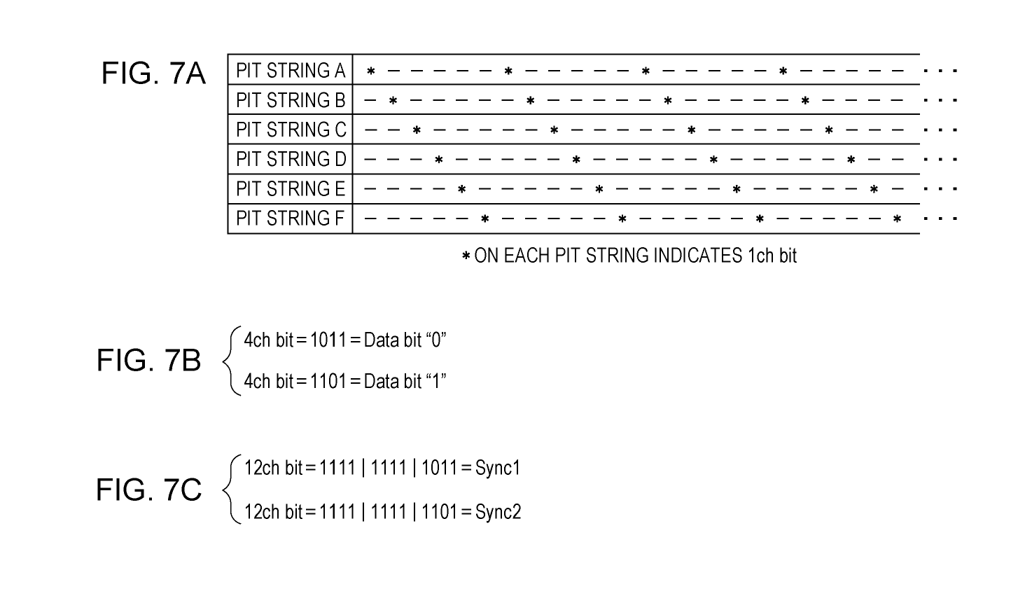

Next, an example of the format of address information recorded on the reference face Ref will be described with reference to FIGS. 7A to 7C.

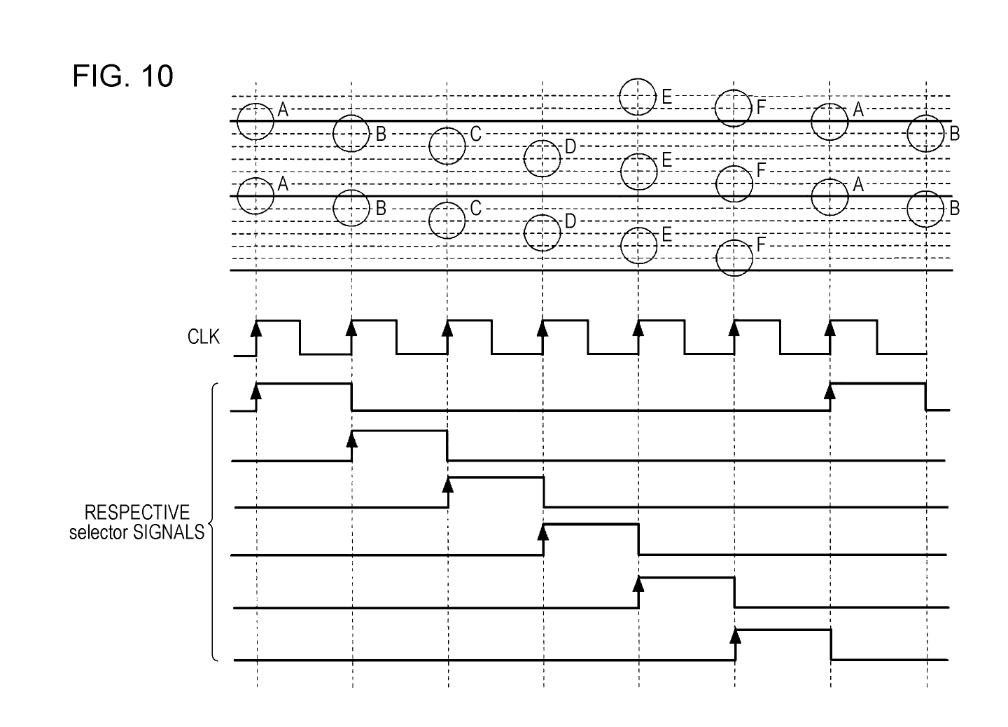

Hereinafter, for convenience of description up to FIG. 10, it is assumed that a signal based on a push-pull signal is generated as a tracking error signal. As clarified from the following description, in a practical configuration as the related example, and in the embodiment, a signal based on a sum signal is generated as the tracking error signal.

In FIGS. 7A to 7C, first, FIG. 7A schematically shows a relationship between pit formable positions of the respective pit strings A to F having different pit string phases. In FIG. 7A, the “*” mark indicates a pit formable position.

Here, as described later, the recording and reproduction device 10 selects one pit string among the pit strings A to F, and performs the tracking servo for the selected one pit string.

However, the problem at this time is that the pit strings A to F are arranged with a pitch exceeding the optical limit in the radius direction. That is to say, in this case, a tracking error signal (push-pull signal) obtained by moving (scanning) an irradiation spot of the servo laser light on a track reflects all the pits of the pit strings A to F, and thus there is no tracking the selected one pit string even if the tracking servo is performed based on the corresponding tracking error signal.

For this reason, this example employs a basic concept that a tracking error signal is sampled at a timing for a pit formable position on the selected pit string, and the tracking servo is performed based on a value of the sampled tracking error signal (that is, intermittently).

In a manner similar thereto, in a case of reading address information as well, a method is employed in which a sum signal is sampled at a timing for a pit formable position on the selected pit string so as to selectively read only information recorded on the selected pit string, and address information is detected based on a value thereof.

In order to correspond to the information detection method, in this example, a format is employed in which “0” or “1” of the channel bit (recording code) is expressed depending on whether or not a pit is formed at a pit formable position. In other words, one pit formable position expresses information corresponding to one channel bit.

Further, one bit of data bit is expressed by a data pattern of “0” and “1” using a plurality of channel bits.

Specifically, in this example, as shown in FIG. 7B, “0” or “1” of the data bit is expressed by four channel bits, and, for example, a pattern of four channel bits “1011” expresses a data bit “0”, and a pattern of four channel bits “1101” expresses a data bit “1”.

At this time, the important thing is that the channel bit “0” is not continuous. That is to say, this is because the continuation of the channel bit “0” means that a period where an error signal may not be obtained is continuous on the basic concept that a servo is performed by intermittently using a tracking error signal as described above, and thus it is very difficult to secure accuracy of the tracking servo.

Therefore, in this example, for example, the condition that the channel bit “0” is not continuous is satisfied according to the above-described definition of the data bit. That is to say, reduction in the accuracy of the tracking servo is suppressed to the minimum by the above-described definition of the data bit.

FIG. 7C shows an example of the synchronization pattern.

For example, the synchronization pattern is expressed by twelve channel bits as shown in the figure, the former eight bits are set to “11111111” which does not match the definition of the data bit, and the pattern of the four channel bits thereafter indicates a distinction between (kind of) the synchronization patterns. Specifically, if a pattern of four channel bits subsequent to the eight bits is “1011”, it indicates Sync 1, and if “1101”, it indicates Sync 2.

In the bulk type recording medium 1, address information is recorded following the above-described synchronization pattern.

As described above, as the address information, absolute position information (radius position information and rotation angle information) is recorded on a disc.

For confirmation, in this example, although a plurality of pit strings A to F are arranged in one track width which is a limit in the related art, the address information is recorded by allocating individual information to each pit string so as to represent a radius position of each pit string (so as to identify each pit string). In other words, the same address information is not recorded on the pit strings A to F arranged in one track width which is a limit in the related art.

As can be seen from the description referring to FIGS. 7A to 7C, pits undergo position recording on the reference face Ref of the bulk type recording medium 1. The position recording indicates a recording method where a part where a pit (or mark) is formed is set to channel data “1”, and parts other than that are set to channel data “0”.

### 1-5. Selection Method of Servo Target Pit String

The method for performing the tracking servo for an arbitrary pit string among the pit strings formed so as to be arranged in a plurality in one track width in the related art as described above, is based on a method which is described below in detail.

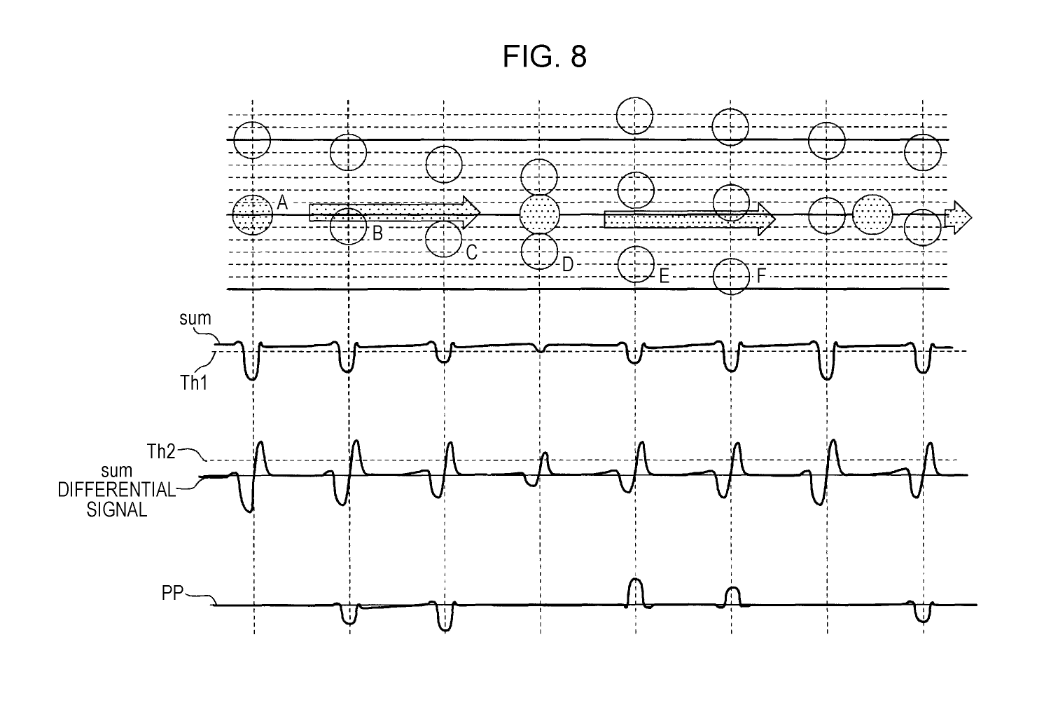

FIG. 8 schematically shows a relationship between a form where a spot of the servo laser light is moved on the reference face Ref according to the rotation driving of the bulk type recording medium 1, and waveforms of a relationship between a sum signal, a sum differential signal, and a push-pull signal PP (also denoted by a PP signal) obtained at this time.

The sum signal is a sum signal of light sensing signals DT-sv from a plurality of light sensing elements which are the servo light sensing unit 29 shown in FIG. 4, and the sum differential signal is a signal obtained by differentiating the sum signal.

Here, for convenience of description in this figure, it is assumed that pits are formed at all the pit formable positions.

As shown in the figure, the sum signal reaches a peak signal level at a cycle corresponding to the arrangement interval of the pits A to F in the pit string formation direction when the beam spot of the servo laser light is moved according to the rotation of the bulk type recording medium 1. In other words, the sum signal indicates an interval (formation cycle) between the pits A to F in the pit string formation direction.

Here, since the spot of the servo laser light is moved along the pit string A in this example shown in the figure, a peak value of the sum signal tends to reach the maximum (absolute value) at the time of passing the position where the pit A is formed in the pit string formation direction, and to gradually decrease over the positions where the pits B to D are formed. Thereafter, the peak value tends to be changed so as to increase in an order of the positions where the pits E and F are formed, and the peak value becomes the maximum again at the position where the pit A is formed. In other words, the peak value of the sum signal increases in an order of the positions where the pits E and F are formed since the spot is influenced by the pits on the pit strings E and F adjacent to the outer circumferential side in the positions where the pits E and F are formed in the pit string formation direction.

In addition, the sum differential signal obtained by differentiating the sum signal, and the PP signal as a tracking error signal can have the waveforms, respectively, as shown in the figure.

The sum differential signal is used to generate a clock CLK corresponding to intervals between positions where the pits are formed (strictly, pit formable positions) on the pit strings A to F in the pit string formation direction.

Specifically, as the clock CLK, a signal which has a position (timing) corresponding to a central position (peak position) of each pit as a rising edge position (timing) is generated by using the sum differential signal.

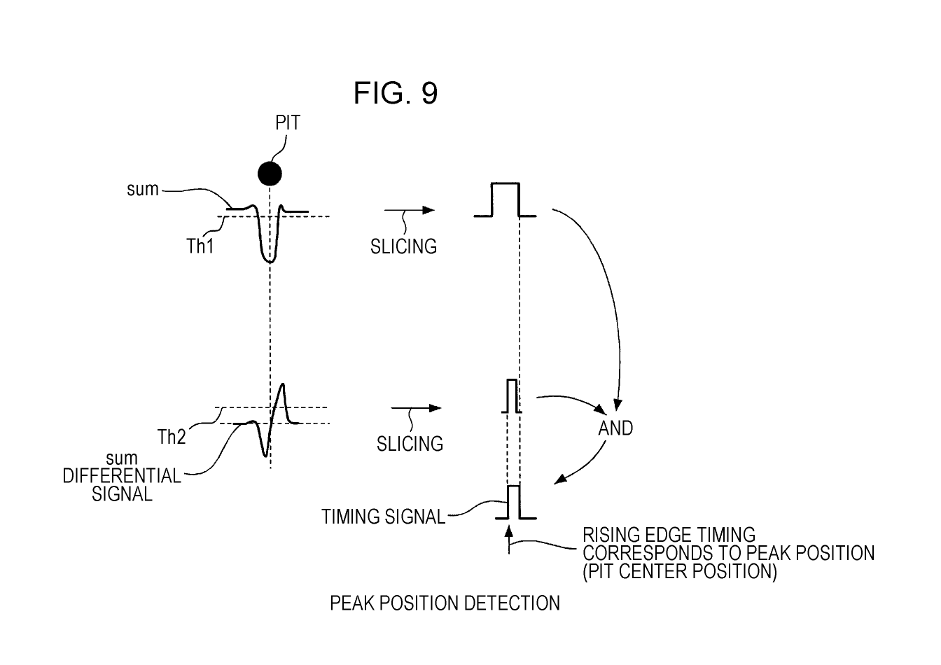

As a generation method of the clock CLK, as shown in FIG. 9, first, a signal is generated by slicing the sum signal with a predetermined threshold value Th1, and, in a similar manner, a signal is generated by slicing the sum differential signal with a predetermined threshold value Th2. In addition, a logical product (AND) of the two signals is taken, and thereby a timing signal having a rising edge timing corresponding to the peak position is generated.

The clock CLK is generated through a PLL (Phase Locked Loop) process where the timing signal generated in this way is used as an input signal (reference signal).

FIG. 10 schematically shows relationships between the clock CLK generated through the above-described procedures, the waveforms of the respective selector signals generated based on the clock CLK, and the pit strings (a portion thereof) formed on the reference face Ref.

As is clear from this figure, the clock CLK is a signal having a cycle corresponding to the formation interval of the pits A to F. Specifically, the clock CLK is a signal having rising edge timings at the peak positions of the pits A to F.

From the clock CLK, six selector signals respectively indicating timings for the positions where the pits A to F can be formed are generated.

Specifically, the selector signals are respectively generated by dividing the clock CLK by ⅙, and the phases thereof are deviated from each other by ⅙ cycle. In other words, each of the selector signals is generated by dividing the clock CLK by ⅙ for each timing, such that the rising edge timings are deviated from each other by ⅙ cycle.

The selector signals are signals which respectively indicate timings for the pit formable positions of the corresponding pit strings A to F. Therefore, an arbitrary selector signal is selected after the selector signals are generated, and a tracking error signal for tracking one pit string among the pit strings A to F can be obtained by sampling and holding a tracking error signal (push-pull signal) at a timing indicated by the selected selector signal. That is to say, the spot of the servo laser light can trace an arbitrary pit string among the pit strings A to F by performing the tracking servo control for the objective lens 20 based on the tracking error signal generated in this way.

### 1-6. Problem of Method of Sampling Push-Pull Signal

Here, when an arbitrary pit string which is a servo target is selected, a signal obtained by sampling and holding the push-pull signal as a tracking error signal for the servo is used in the above description; however, in a case of using the push-pull signal as such, there is concern that exact tracking error information may not be obtained due to so-called tilt (skew) or lens shift of the objective lens 20.

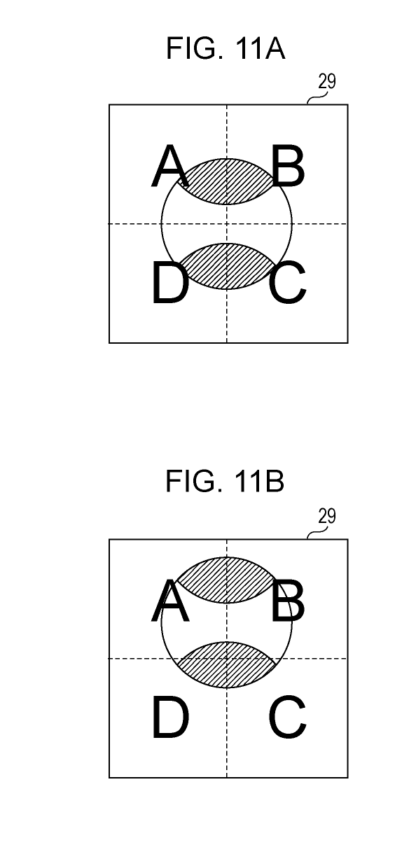

FIGS. 11A and 11B are diagrams illustrating misalignment of a reflection light sensing spot due to the tilt or the lens shift, where FIG. 11A shows a reflection light spot (light sensing spot) on the servo light sensing unit 29 in an ideal state where the tilt or the lens shift does not occur, and FIG. 11B shows a reflection light spot on the servo light sensing unit 29 in a case where the tilt or the lens shift occurs.

In FIGS. 11A and 11B, the shaded parts shown in the reflection light spots indicate overlapping regions (overlapping regions of the push-pull signals) of primary diffractive light components from the pits formed on the disc.

First, as a premise, if a set of light sensing elements A and B and a set of light sensing elements C and D in the figure are adjacent to each other in a direction corresponding to the radius direction of the disc, the push-pull signal (PP) is calculated by

PP=(Ai+Bi)−(Ci+Di) [Equation 1].

Here, in Equation 1, Ai, Bi, Ci, and Di respectively denote light sensing signals of the light sensing elements A, B, C and D.

Here, it is assumed that an irradiation spot of the servo laser light exactly traces a target pit string. In this case, a value of the push-pull signal PP calculated by the above Equation 1 becomes “0” in the ideal state shown in FIG. 11A where the tilt or the lens shift does not occur.

In contrast, in a case where the reflection light spot position is misaligned due to the tilt or the lens shift as shown in FIG. 11B, a value of the push-pull signal PP calculated by Equation 1 becomes a value different from “0” which is originally obtained, and thus an error occurs.

As can be seen therefrom, an offset due to the tilt or the lens shift occurs in the push-pull signal PP.

If the offset component due to the tilt or the lens shift can be disregarded, the generation method of a tracking error signal is effective as described above; however, it is preferable that the above-described offset component does not overlap a tracking error signal in order to improve stability of the tracking servo control.

In the related art, as a tracking error detection method for preventing an influence of an offset due to the tilt or the lens shift, there is used a so-called three-spot method; however, it is necessary to add optical components such as a grating in the three-spot method, and thus component costs or adjustment costs increase.

In addition, as a tracking error detection method for preventing an influence of the offset, there is known a DPP (Differential Push Pull) method; however, even in the DPP method, it is necessary to add a grating, and thus component costs or adjustment costs increase.

In order to solve the problems of the tracking error detection methods in the related art and to prevent an influence of the offset component due to the tilt or the lens shift, a tracking error signal is generated by a method using the sum signal as described below in the related example (this is also true of the embodiment).

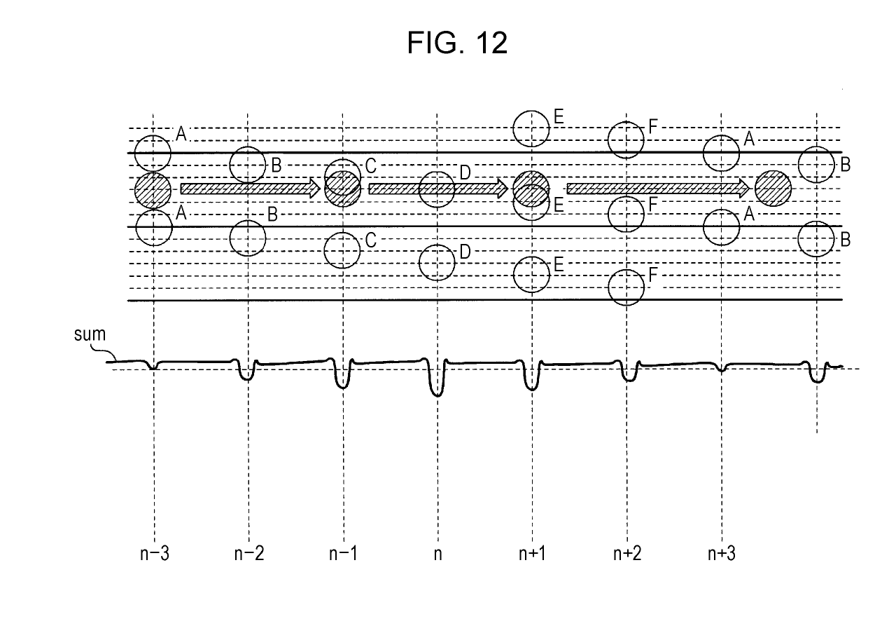

FIG. 12 is a diagram illustrating a generation method of a tracking error signal in the related example.

FIG. 12 shows a movement trajectory (shaded part) of a spot position of the servo laser light in a state where the tracking servo is performed so as to trace the pit string D among the pit strings A to F formed on the reference face Ref, and a waveform of the sum signal obtained according to the movement of the servo laser light.

For example, as shown in FIG. 12, when the spot of the servo laser light exactly traces the pit string D, a value of the sum signal tends to have the minimal value at the timing (n in the figure) matching the pit formation position on the pit string D. In addition, a value of the sum signal tends to gradually become large at the pit formation positions of the pit strings where a phase difference with the pit string D increases.

At this time, a value of the sum signal has the same value at the timings (n−1 and n+1 in the figure) matching the pit formation positions of the pit strings C and E which are respectively adjacent to the pit string D (that is, the phase difference is the same as each other), and also has the same value at the timings (n−2 and n+2 in the figures) matching the pit formation positions of the pit strings B and F which are separated (that is, the phase difference is the same as each other) from the pit string D by the same distance (distance in the radius direction).

Here, if the spot of the servo laser light traces a position deviated from the pit string D in the radius direction unlike the state shown in the figure, it can be seen that values of the sum signal at the respective pit formation positions in the sets of the pit strings having the same phase difference with respect to the pit string D are different.

That is to say, as can be seen therefrom, the values of the sum signal at the respective pit formation position in the sets of the pit strings having the same phase difference with respect to the pit string which is a target of the tracking servo reflect an error in the pit string which is a target of the tracking servo in the tracking direction. Specifically, the tracking error information can be obtained by calculating differences between the values of the sum signal at the respective pit formation positions in the sets of the pit strings having the same phase difference.

In consideration thereof, in the related example, a tracking error signal is generated based on the sum signal by the following detailed method.

In other words, first, two pit strings having the same phase difference with respect to a pit string which is a target of the tracking servo are selected. Specifically, in this example, pit strings adjacent to the pit string which is a target of the tracking servo are selected.

Further, values of the sum signal are sampled at timings (n−1 and n+1 in FIG. 12) corresponding to the pit formable positions of the respective selected pit strings, and differences between the sampled values of the sum signal are calculated. The calculated result is a tracking error signal for the pit string which is a servo target.

### 1-7. Overall Internal Configuration of Spot Position Control Device

On the basis of the above description, the overall internal configuration of the spot position control device (the recording and reproduction device 10) according to the related example will be described with reference to FIG. 13.

In addition, FIG. 13 shows a portion of the internal configuration of the optical pickup OP through extraction, and, specifically, shows only the recording and reproduction laser 11, the lens driving unit 16, and the biaxial actuator 21 among the constituent elements shown in FIG. 4.

In FIG. 13, the recording and reproduction device 10 is provided with the spindle motor 44.

The spindle motor 44 includes an FG (Frequency Generator) motor, and rotatably drives the bulk type recording medium 1 at a constant velocity (constant rotation velocity).

The spindle motor 44 starts or stops the rotation in response to an instruction from the controller 41.

In addition, the recording and reproduction device 10 includes a recording processing unit 31, a recording and reproduction light matrix circuit 32, and a reproduction processing unit 33 in the figure, as a signal processing system for performing recording and reproduction for the bulk layer 5 or for performing a focus servo control or a tracking servo control (that is, a position control based on reflection light of the recording and reproduction laser light) for the objective lens 20 when recording marks are reproduced.

The recording processing unit 31 receives data to be recorded (recording data) on the bulk type recording medium 1. The recording processing unit 31 performs addition of error correction code to the input recording data or a predetermined recording modulation coding for the recording data, and thereby obtains recording modulation data stream which is practically recorded on the bulk type recording medium 1, for example, a binary data stream of “0” and “1”. The recording processing unit 31 controls emission driving of the recording and reproduction laser 11 in the optical pickup OP, in response to a recording pulse signal RCP based on the recording modulation data stream generated in this way.

The recording and reproduction light matrix circuit 32 includes a current-voltage conversion circuit, a matrix operation and amplification circuit, and the like, and generates signals necessary for a matrix operation process in response to a light sensing signal DT-rp (output current) from a plurality of light sensing elements which are the recording and reproduction light sensing unit 23 shown in FIG. 4.

Specifically, the recording and reproduction light matrix circuit 32 generates a radio frequency signal (hereinafter, referred to as a reproduction signal RF) corresponding to a reproduction signal for the above-described recording modulation data stream, a focus error signal FE-rp for a focus servo control, and a tracking error signal TE-rp for a tracking servo control.

The reproduction signal RF generated by the recording and reproduction light matrix circuit 32 is supplied to the reproduction processing unit 33.

The focus error signal FE-rp and the tracking error signal TE-rp are supplied to the recording and reproducing light servo circuit 34.

The reproduction processing unit 33 obtains reproduction data to which the recording data is recovered by performing a reproduction process for recovering the above-described recording data such as a binarization process, decoding of the recording modulation code, and an error correction process, for the reproduction signal RF.

The recording and reproduction light servo circuit 34 generates a focus servo signal FS-rp and a tracking servo signal TS-rp based on the focus error signal FE-rp and the tracking error signal TE-rp supplied from the matrix circuit 32, and performs a focus servo control and a tracking servo control for the recording and reproduction laser light by driving the focus coil and the tracking coil of the biaxial actuator 21 in response to a focus driving signal FD-rp and a tracking driving signal TD-rp based on the focus servo signal FS-rp and the tracking servo signal TS-rp.

For confirmation, the servo control of the biaxial actuator 21 (the objective lens 20) based on the reflection light of the recording and reproduction laser light is performed during the reproduction.

Further, in response to an instruction from the controller 41 so as to correspond to the reproduction, the recording and reproduction light servo circuit 34 turns off a tracking servo loop and gives a jump pulse to the tracking coil, thereby realizing a track jumping operation, a pull-in control of the tracking servo, and the like. In addition, a pull-in control of the focus servo or the like is performed.

In addition, the recording and reproduction device 10 includes a servo light matrix circuit 35, an address detection circuit 36, a sample-and-hold circuit SH1, a sample-and-hold circuit SH2, a subtractor 37, a servo light servo circuit 38, a clock generation circuit 39, a selector signal generation and selection unit 40, an offset generation unit 42, and an adder 43, as a signal processing system for reflection light of the servo laser light.

Among the constituent elements, the offset generation unit 42 and the adder 43 will be described again later.

In addition, in a signal process system for reflection light and servo laser light, the servo light matrix circuit 35 generates necessary signals based on a light sensing signal DT-sv from a plurality of light sensing elements of the servo light sensing unit 29 shown in FIG. 4.

Specifically, the servo light matrix circuit 35 generates a sum signal which indicates a sum of light sensing signals from the plurality of light sensing elements, and a focus error signal FE-sv for a focus servo control.

As shown in the figure, the sum signal is applied to the sample-and-hold circuit SH1, the sample-and-hold circuit SH2, the clock generation circuit 39, and the address detection circuit 36.

The focus error signal FE-sv is supplied to the servo light servo circuit 38.

The address detection circuit 36 receives a selector signal S_Ad which is generated and selected by the selector signal generation and selection unit 40 as described later, and detects address information (absolute position information including at least radius position information or rotation angle information) recorded on the reference face Ref, based on a result of sampling values of the sum signal from the servo light matrix circuit 35 at a timing (in this case, a section where the selector signal S_Ad is in a high level) for a pit formable position indicated by the selector signal S_Ad.

Here, as described with reference to FIGS. 7A to 7C, in a case of this example, address information for each pit string records whether or not a pit is formed at a pit formable position in the pit string, as one channel bit information. In order to correspond thereto, the address detection circuit 36 identifies a value of the sum signal at the rising edge timing of the selector signal S_Ad so as to identify data “0” or “1” of one channel bit, and performs an address decoding process according to the format described with reference to FIGS. 7A to 7C based on the result thereof, thereby detecting (reproducing) recorded address information.

The address information detected by the address detection circuit 36 is supplied to the controller 41.

The clock generation circuit 39 generates the clock CLK according to the procedures described above.

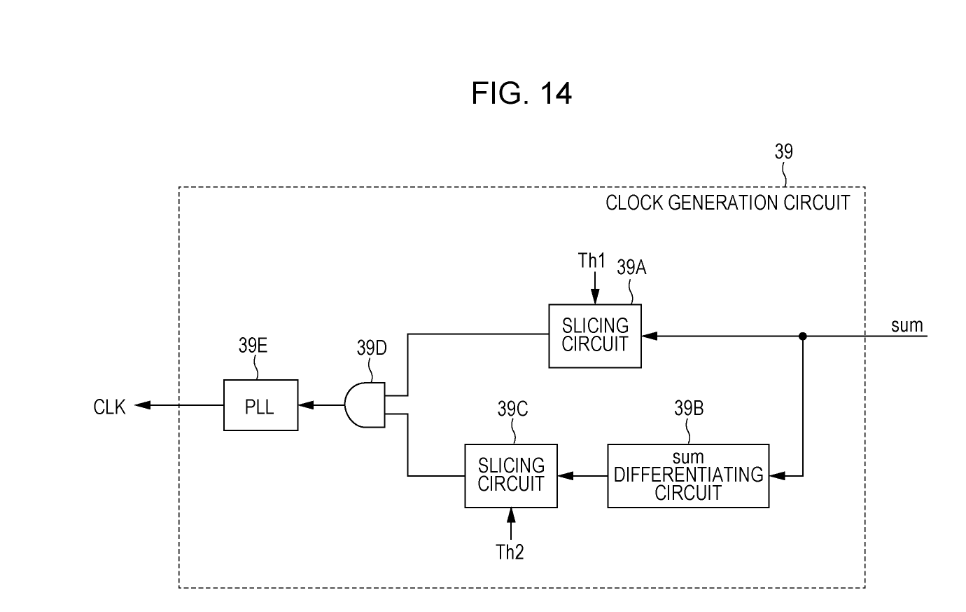

FIG. 14 shows an internal configuration of the clock generation circuit 39.

In FIG. 14, the clock generation circuit 39 includes a slicing circuit 39A, a sum differentiating circuit 39B, a slicing circuit 39C, an AND gate circuit 39D, and a PLL circuit 39E.

The sum signal is input to the slicing circuit 39A and the sum differentiating circuit 39B, as shown in the figure. The slicing circuit 39A slices the sum signal based on the set threshold value Th1, and outputs the resultant to the AND gate circuit 39D.

The sum differentiating circuit 39B differentiates the sum signal and generates the sum differential signal described above. The slicing circuit 39C slices the sum differential signal generated by the sum differentiating circuit 39B based on the set threshold value Th2, and outputs the resultant to the AND gate circuit 39D.

The AND gate circuit 39D applies the logical product (AND) to the output from the slicing circuit 39A and the output from the slicing circuit 39C, thereby generating a timing signal described above.

The PLL circuit 39E performs a PLL process using the timing signal obtained by the AND gate circuit 39D as an input signal, thereby generating a clock CLK.

Referring to FIG. 13 again, the clock CLK generated by the clock generation circuit 39 is supplied to the selector signal generation and selection unit 40.

The selector signal generation and selection unit 40 generates the respective selector signals based on the clock CLK, and selects and outputs an instructed selector signal (the selector signals S_1, S_2 and S_Ad) among the generated selector signals.

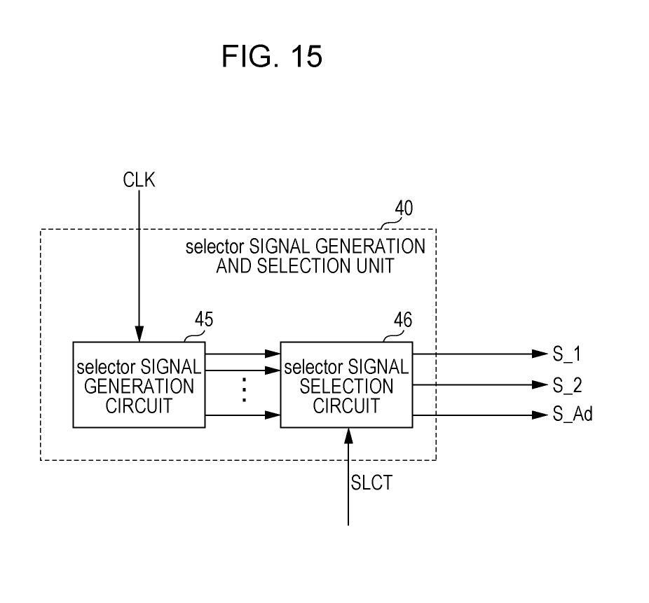

FIG. 15 shows an internal configuration of the selector signal generation and selection unit 40.

As shown in the figure, the selector signal generation and selection unit 40 includes a selector signal generation circuit 45, and a selector signal selection circuit 46.

The selector signal generation circuit 45 generates six selector signals indicating timings for pit formable positions of the respective pit strings A to F based on the clock CLK. Specifically, the selector signal generation circuit 45 generates signals which are obtained by dividing the clock CLK by ⅙ and of which phases are respectively deviated by ⅙ cycle, thereby obtaining the six selector signals.

The six selector signals are supplied to the selector signal selection circuit 46.

The selector signal selection circuit 46 selects and outputs, as the selector signal S_Ad, a selector signal having a phase which is instructed to be supplied to the address detection circuit 36 by a selection signal SLCT from the controller 41, among the selector signals supplied from the selector signal generation circuit 45. In addition, the selector signal selection circuit 46 selects and outputs selector signals which are instructed by the selection signal SLCT, are necessary in the above-described generation method of a tracking error signal, and have phases corresponding to the pit strings having the same phase difference with respect to a pit string which is a servo target, as the selector signal S_1 and the selector signal S_2.

In addition, as can be seen from the above description, in this example, in relation to the selector signal S_1 and the selector signal S_2, the controller 41 instructs selector signals corresponding to the pit strings adjacent to the pit string which is a servo target, to be output.

The selector signal S_1 output from the selector signal selection circuit 46 is supplied to the sample-and-hold circuit SH1, and the selector signal S_2 is supplied to the sample-and-hold circuit SH2.

The sample-and-hold circuit SH1 samples and holds a value of the sum signal supplied from the matrix circuit 35 at a timing indicated by the selector signal S_1, and outputs the resultant to the subtractor 37.

The sample-and-hold circuit SH2 samples and holds a value of the sum signal supplied from the matrix circuit 35 at a timing indicated by the selector signal S_2, and outputs the resultant to the subtractor 37.

The subtractor 37 obtains the tracking error signal TE-sv by subtracting the output value sampled and held by the sample-and-hold circuit SH2 from the output value sampled and held by the sample-and-hold circuit SH1. As can be seen from the above description, the tracking error signal TE-sv is a signal indicating a tracking error in a pit string which is selected as a servo target.

As shown in the figure, the tracking error signal TE-sv is supplied to the servo light servo circuit 38 via the adder 43 described later.

The servo light servo circuit 38 generates a focus servo signal FS-sv and a tracking servo signal TS-sv based on the focus error signal FE-sv and the tracking error signal TE-sv (after via the adder 43).

During the recording, in response to an instruction from the controller 41, the servo light servo circuit 38 drives the focus coil and the tracking coil of the biaxial actuator 21 using a focus driving signal FD-sv and a tracking driving signal TD-sv generated based on the focus servo signal FS-sv and the tracking servo signal TS-sv, thereby realizing a focus servo control for the servo laser light, and a tracking servo control targeting a necessary pit string.

Further, in response to an instruction from the controller 41 so as to correspond to the recording, the servo light servo circuit 38 turns on the tracking servo and the focus servo, thereby performing servo pull-in for each of tracking and focus.

The controller 41 is constituted by, for example, a microcomputer having a CPU (Central Processing Unit) and a memory (storage device) such as a ROM (Read Only Memory) or a RAM (Random Access Memory), and, for example, controls the overall recording and reproducing device 10 by performing controls and processes according to programs stored in the ROM or the like.

For example, the controller 41 controls (sets) a focal position of the recording and reproduction laser light based on a value of the offset of-L which is set in advance so as to correspond to each layer position L as described above. Specifically, the controller 41 drives the lens driving unit 16 in the optical pickup OP based on a value of the offset of-L set so as to correspond to an information recording layer position L to be recorded, thereby selecting a recording position in the bulk layer 5 in the depth direction.

In addition, the controller 41 also performs a control for realizing servo control switching of the objective lens 20 between the recording and the reproduction. Specifically, at the time of the recording, the controller 41 instructs the servo light servo circuit 38 to output the focus driving signal FD-sv and the tracking driving signal TD-sv, and instructs the recording and reproduction light servo circuit 34 to stop output of the focus driving signal FD-rp and the tracking driving signal TD-rp.

On the other hand, at the time of the reproduction, the controller 41 instructs the recording and reproduction light servo circuit 34 to output the focus driving signal FD-rp and the tracking driving signal TD-rp, and instructs the servo light servo circuit 38 to stop output of the focus driving signal FD-sv and the tracking driving signal TD-sv.

In addition, the controller 41 performs a seek operation control for a spot position of the servo laser light. In other words, the controller 41 instructs the servo light servo circuit 38 to move a spot position of the servo laser light to a predetermined target address on the reference face Ref, and instructs the selector signal generation and selection unit 40 (the selector signal selection circuit 46) to select selector signals using the selection signal SLCT.

Here, the seek operation control in this case is substantially performed by the controller 41, for example, in the following procedures.

The controller 41 instructs 1) to move the optical pickup OP to the vicinity of a target address by moving the overall the optical pickup OP using the above-described slide driving unit, 2) to turn on a focus servo for the servo laser light, 3) to generate the clock CLK and the respective selector signals based on the sum signal, 4) to perform a tracking servo control for an arbitrary pit string based on an arbitrarily selected selector signal, and 5) to perform a jumping operation from an address to a target address since the address information (information for identifying a pit string) can be read by performing the tracking servo in the above 4). The controller 41 instructs the servo light servo circuit 38 to perform the operations in the above 1) and 2). In addition, in order to select an arbitrary selector signal in the above 4), the controller 41 instructs the selector signal generation and selection unit 40 to select the selector signal S_1 and the selector signal S_2 corresponding to phases of pit strings adjacent to a pit string having a predefined phase, using the selection signal SLCT.

In addition, in order to realize the operation in the above 5), the controller 41 instructs the selector signal generation and selection unit 40 to select a selector signal corresponding to the above-described “pit string having a predefined phase” (that is, a pit string to be selected as a servo target), in relation to the selector signal S_Ad.

Further, the controller 41 performs a control such that address information detected by the address detection circuit 36 is input in response to the instructed selector signal S_Ad, a movement amount necessary up to the target address is calculated based on the corresponding address information, and the jumping operation is performed by the movement amount.

A detailed position control method as the related example for moving a spot position such as a track jumping operation to be executed on the reference face Ref during the seek operation will be described below.

### 1-8. Detailed Method for Realizing Spot Movement Through Closed-Loop Control

With the above-described configuration of the recording and reproduction device 10, it is possible to perform the tracking servo for an arbitrary pit string among the pit strings having the respective phases, formed on the reference face Ref.

In the related example, on the premise of the configuration which can perform the tracking servo of tracking one pit string on the reference face Ref, a spot movement of one track or more such as the track jumping operation is realized through the closed-loop control by the following method.

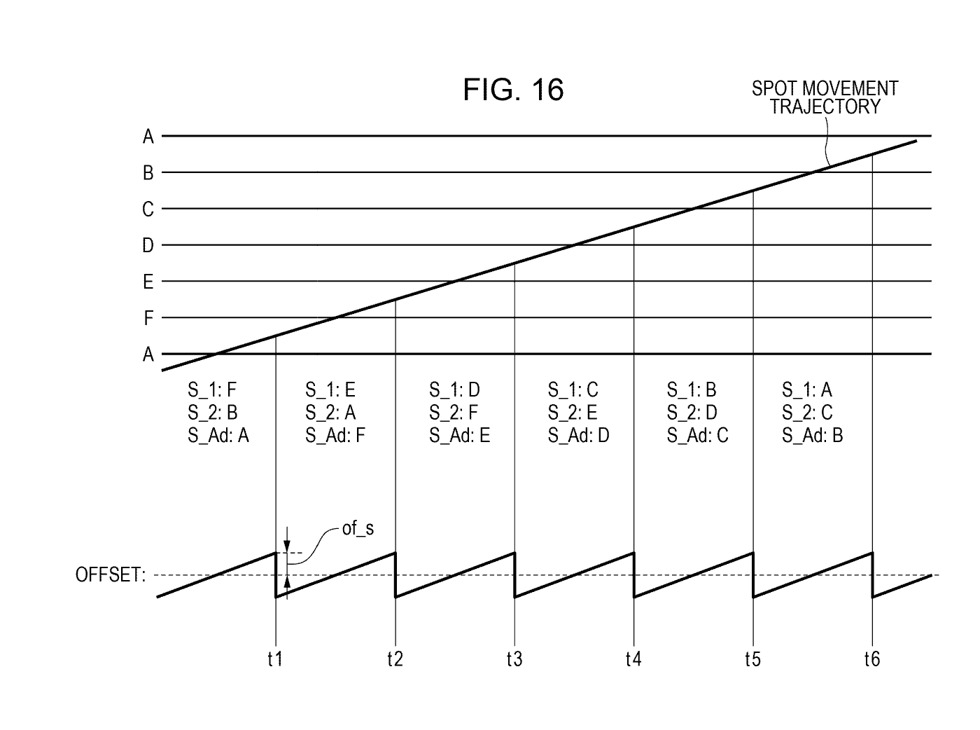

FIG. 16 is a diagram illustrating a detailed position control method as the related example for realizing a spot movement through the closed-loop control.

FIG. 16 shows relationships between a waveform of offset to be given to a tracking servo loop in order to realize a spot movement, transitions of the selector signal S_1 and the selector signal S_2 to be sequentially output by giving the offset, sequential switching of a servo target pit string according to the transitions of the selector signals S_1 and S_2, and a movement trajectory of the spot position generated by giving the offset.

FIG. 16 also shows a transition of the selector signal S_Ad to be sequentially switched according to the movement of the spot position.

Here, in order to move a spot position of the servo laser light in the disc radius direction by one track or more in terms of the track width in the related art, the spot position is moved so as to step over (cross) the pit strings in the radius direction one by one. In addition, the spot position is moved by giving an offset of which a value gradually increases with the passage of time, to the tracking servo loop.

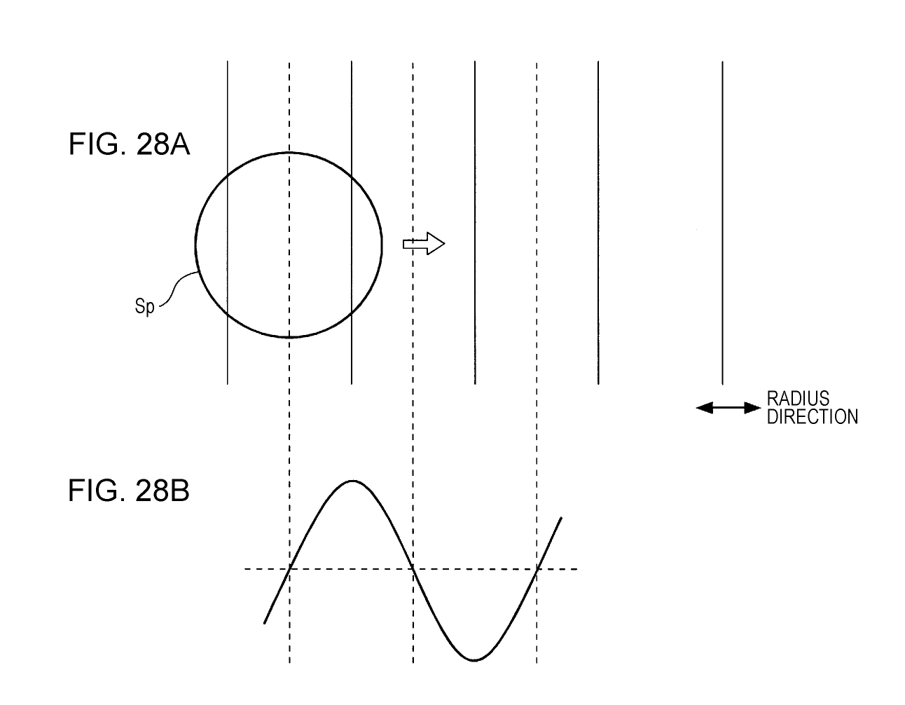

At this time, the spot position is gradually moved apart from the pit string which is a servo target by giving the offset, and if the state where the spot position is gradually moved apart from the pit string which is a servo target is continued, aliasing described with reference to FIG. 28B occurs in the tracking error signal TE-sv, or the linearity is considerably deteriorated even before the aliasing occurs.

Therefore, in the related example, when the spot position is separated from the pit string which is a servo target, to a certain degree, a pit string which will be a servo target is sequentially changed to an adjacent pit string. That is to say, the spot position is gradually moved by giving an offset to the tracking servo loop, and a pit string which will be a servo target is sequentially changed to an adjacent pit string.

Here, in a case of the position control method, it is necessary to define in advance which position is a timing (position) where a pit string which is a servo target is switched to an adjacent pit string. In this example, such a changing timing of a servo target pit string is set to a position which is an exactly middle point with adjacent pit strings.

At this time, a slope of the offset is fixed to a predetermined value set in advance, and thus a time length from a certain pit string until the spot position reaches a pit string adjacent thereto is an existing value. That is to say, a time length until the spot position reaches a middle point of the adjacent pit string therefrom is an existing value based on the slope value of the offset.

In the related example, a servo target pit string is changed to a pit string adjacent to a pit string which has been a servo target using information for the existing time length reaching the middle point.

In addition, in order to correspond to the change in a servo target pit string at a timing which reaches a middle point between adjacent pit strings, the offset for displacing the spot position in the radius direction uses an offset having a waveform of which a polarity is changed at the middle point as shown in FIG. 16.

Here, an offset value when the spot is located at the middle point position becomes, for example, “+of_s” during a servo targeting the pit string A, and becomes “−of_s” during a servo targeting the adjacent pit string B. Therefore, it is necessary to reverse polarities of the offset at a changing timing of a servo target pit string which is a timing reaching the middle point. From this, a waveform of the offset to be given in this case becomes a saw-tooth wave as shown in the figure.

For confirmation, the waveform of the offset can be also set based on information for the above-described existing time length.

In the position control method as the related example, while the offset having the predefined saw-tooth wave is given to the tracking servo loop, for each timing where the spot position reaches a predetermined position set in advance between adjacent pit strings, which is the middle point, a pit string which is a target of the tracking servo is repeatedly changed to a pit string adjacent to an outer circumferential side (or an inner circumferential side) of a pit string which has been a servo target until the timing.

At this time, in relation to the tracking servo, a pit string which is a target thereof is switched; however, the servo state is maintained, and thus the spot position is moved through the closed-loop control.

In addition, for confirmation, the sequential switching between servo target pit strings and the displacement of the spot position by the giving of the offset are realized by the structure of the reference face Ref where the pit strings are arranged with a pitch exceeding the optical limit in the radius direction as the structure described with reference to FIG. 5. That is to say, this is because if the pit strings may not be arranged with a pitch exceeding the optical limit, the tracking servo is deviated due to the giving of the offset.

A detailed selection method of the respective selector signals to be performed for realizing the spot position control as the above-described related example is shown in FIG. 16.

In addition, FIG. 16 shows a form where the spot position passes through the pit string A, the pit string F, the pit string E, the pit string D, the pit string C, and the pit string D, and also shows the selector signal S_1, the selector signal S_2, and the selector signal S_Ad which will be selected sequentially at this time.

As shown in the figure, here, a timing corresponding to the middle point between the pit strings A and F is set to the time point t1. Thereafter, timings corresponding to the respective middle points between the pit strings F and E, the pit strings E and D, the pit strings D and C, the pit strings C and B, the pit strings B and A are respectively set to t2, t3, t4, t5, and t6.

The pit string A is a servo target in the step before the time point t1, and thus a selector signal having a phase corresponding to the pit string F is selected as the selector signal S_1, and a selector signal having a phase corresponding to the pit string B is selected as the selector signal S_2 as shown in the figure. That is to say, selector signals for the pit strings F and B (having the same phase difference) which are adjacent to the servo target pit string A are respectively selected.

In addition, a selector signal having a phase corresponding to the pit string A which is a servo target is selected as the selector signal S_Ad.

In addition, as can be seen from the description referring to FIG. 13 or 15, the controller 41 instructs the selector signal generation and selection unit 40 (the selector signal generation circuit 45) to select the selector signals S_1, S_2 and S_Ad using the selection signal SLCT.

When the time point t1 comes, a selector signal having a phase corresponding to the pit string E is selected as the selector signal S_1 and a selector signal having a phase corresponding to the pit string A is selected as the selector signal S_2, such that a servo target pit string is switched to the pit string F.

In addition, as the selector signal S_Ad, a selector signal having a phase corresponding to the pit string F is selected.

In the same manner thereafter, as the selector signals S_1 and S_2, selector signals for pit strings adjacent to a pit string which is a servo target are selected, and, as the selector signal S_Ad, a selector signal for the pit string which is a servo target is selected, for each time point to which is a switching timing. Specifically, as shown in the figure, at the time point t2, “S_1:D, S_2:F, S_Ad:E” are selected, at the time point t3, “S_1:C, S_2:E, S_Ad:D” are selected, at the time point t4, “S_1:B, S_2:D, S_Ad:C” are selected, at the time point t5, “S_1:A, S_2:C, S_Ad:B” are selected.

Here, the giving of the offset having the saw-tooth wave as shown in FIG. 16 is performed by the offset generation unit 42 and the adder 43 based on an instruction from the controller 41 in the recording and reproduction device 10 shown in FIG. 13.

The offset generation unit 42 generates and outputs a saw-tooth wave signal having a predetermined slope set in advance based on an instruction from the controller 41.

The adder 43 adds the saw-tooth wave signal generated and output by the offset generation unit 42 in this way to the tracking error signal TE-sv input from the subtractor 37.

With such a configuration, the controller 41 instructs the offset generation unit 42 to output and stop outputting the saw-tooth wave signal, and instructs the selector signal generation and selection unit 40 to select the selector signals S_1 and S_2 for each predetermined timing which is the above-described middle point, thereby performing a track jumping operation by an arbitrary movement amount.

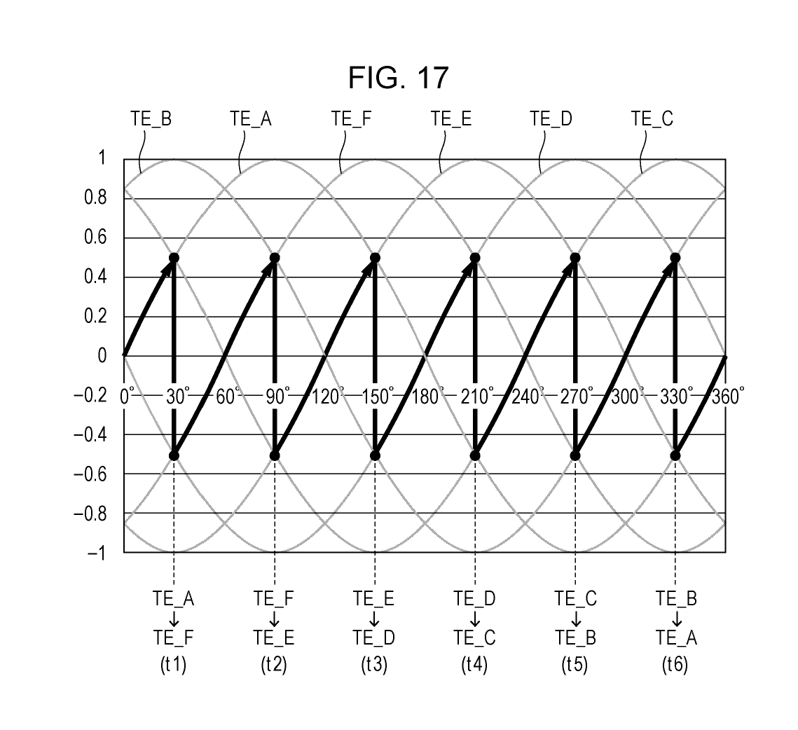

Here, for confirmation, the position control method as the related example is shown in FIG. 17 so as to correspond to the tracking error signal TE-sv for each pit string.

In FIG. 17, the tracking error signals TE_A to TE_F indicate a tracking error signal TE-sv for the respective pit strings A to F. In addition, the waveforms of the tracking error signals TE_A to TE_F indicate waveforms when a spot position is gradually moved in the radius direction.

In this case, there are six phases of A to F as phases of the pit strings, and thus the phase of each tracking error signal TE (TE-sv) has a phase relationship deviation of 60° as shown in the figure.

The above-described position control method as the related example can be expressed as sequentially tracing sections around zero points in an order of the tracking error signals TE_A, TE_F, TE_E, TE_D, TE_C, TE_B, TE_A . . . as denoted with the thick lines in the figure.

### 2. Embodiments

### 2-1. Problems of Related Example

According to the above-described related example, the position control of moving a spot position in a movement amount causing aliasing in a tracking error signal, such as a track jumping operation, can be realized through the closed-loop control.

However, in the above-described method of the related example, a timing reaching a middle point between pit strings is estimated from a slope of the offset, servo target pit strings are switched based on the timing, and thus there is concern that the switching timing may not match a practical middle point.

As such, in a case where the practical middle point does not match the switching timing between servo target pit strings, there is concern that a value of the offset of which polarities are reversed at the switching timing may not become a value corresponding to a tracking error amount of the practical spot position with respect to a pit string which is a new servo target, and thereby a servo control may not be stable.

In addition, first of all, since the method of the related example uses the tracking error signal TE-sv itself in which aliasing occurs if a tracking error amount is equal to or more than a certain amount in a manner similar to the optical disc system in the related art, when a spot position is moved, the offset having the saw-tooth wave as shown in FIG. 16 is given to the tracking servo loop.

For this reason, the method of the related example may not realize a control of moving a spot position to a target position just by giving an offset corresponding to a target value of a spot movement amount.

### 2-2. Position Control Method According to Embodiment

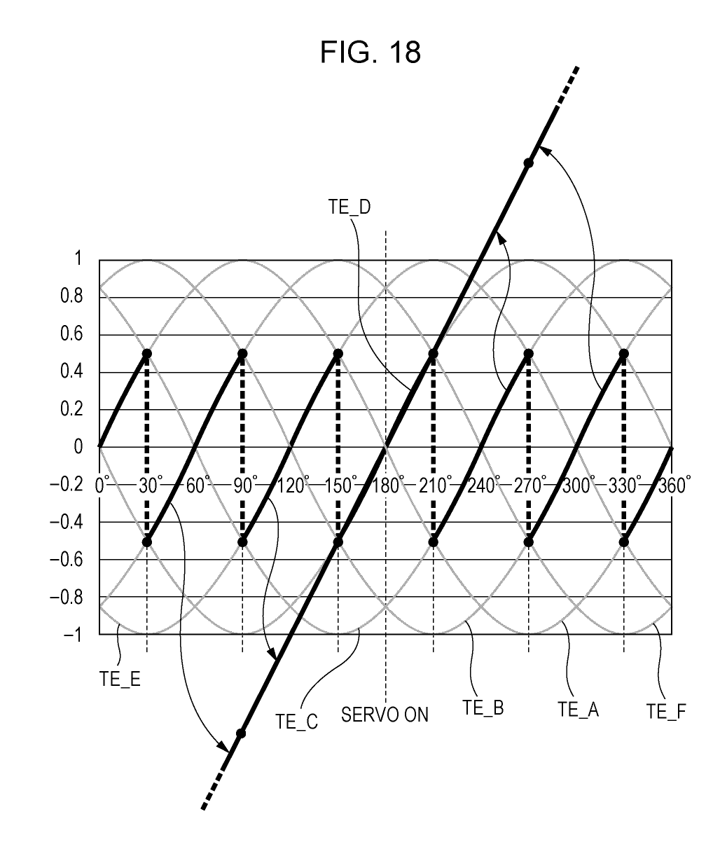

Therefore, in the embodiment, as shown in FIG. 18, by connecting waveforms around the zero-cross points of the tracking error signals TE (TE_A to TE_F) for the pits having the phases A to F when the spot position is moved in the radius direction, a linear tracking error signal which can express a tracking error amount from a servo target pit string linearly is generated, and the tracking servo is performed based on the linear tracking error signal.

That is to say, by configuring a tracking servo control system based on such a linear tracking error signal, as a value of the offset to be given to the servo loop in order to move the spot position to a target position, only a value corresponding to a target movement amount from a servo target pit string can be given.

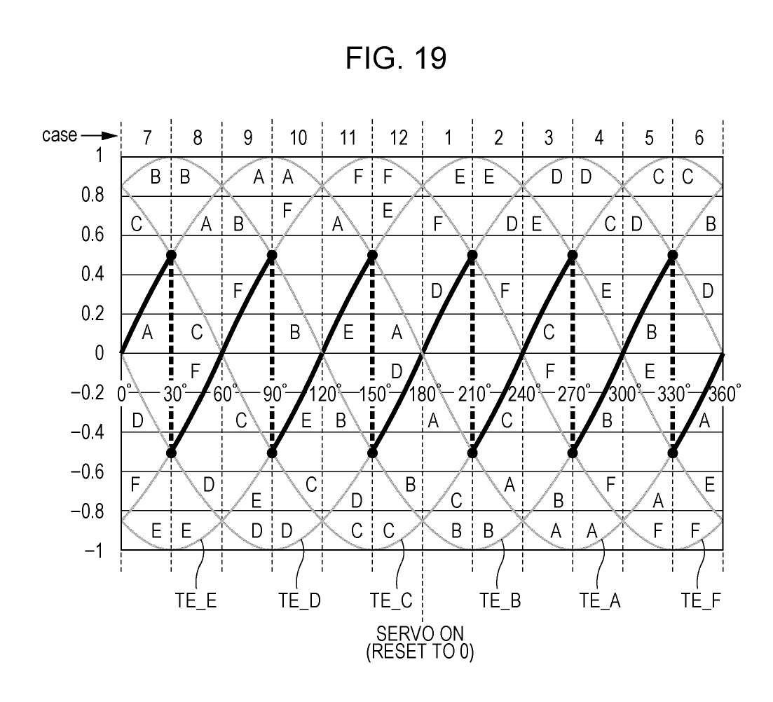

FIG. 19 is a diagram illustrating a detailed generation method of the linear tracking error signal (hereinafter, also referred to as a linear error signal) as shown in FIG. 18.

In addition, FIG. 19 shows waveforms of tracking error signals TE_A to TE_F obtained when a spot position of the servo laser light is moved in the radius direction.

First, as can be seen from FIG. 19 by referring thereto, the magnitude correlation of the amplitudes of the tracking error signals TE_A to TE_F are varied with the passage of time according to the movement of the spot position in the radius direction.

In this example, Case division is performed for distinction of the magnitude correlation of the amplitudes of the tracking error signals TE_A to TE_F in relation to the generation of the linear error signal. Specifically, in this case, in order to correspond to the six pit string phases, Case is divided into Case 1 to Case 12.

If the amplitudes of the tracking error signals TE_A to TE_F are denoted by A to F, the definitions of Case 1 to Case 12 are as follows.

E<F<D<A<C<B Case 1

E<D<F<C<A<B Case 2

D<E<C<F<B<A Case 3

D<C<E<B<F<A Case 4

C<D<B<E<A<F Case 5

C<B<D<A<E<F Case 6

B<C<A<D<F<E Case 7

B<A<C<F<D<E Case 8

A<B<F<C<E<D Case 9

A<F<B<E<C<D Case 10

F<A<E<B<D<C Case 11

F<E<A<D<B<C Case 12

In this example, the amplitudes of the respective tracking error signals TE_A to TE_F are sequentially monitored, and the distinctions of the respective Cases defined as described above are determined. In addition, each Case determined in this way is calculated as described below, thereby generating the linear error signal.

In addition, a calculation example shown in the following is based on the premise of a case where a pit string where the servo is initially turned on is the pit string D as shown in FIG. 19. That is to say, the premise is that a state where a spot is located on the pit string D is a zero point of the linear error signal.

Here, in the following calculation example, P(n) denotes an output value of the linear error signal at each time point, and A to F respectively denote amplitude values of the tracking error signals TE_A to TE_F.

In addition, Pₚᵣₑᵥ denotes an amplitude value of a tracking error signal TE (one of TE_A to TE_F) which is selected in the previous Case at a switching timing from the previous Case.

Further, HPK denotes an amplitude value of a tracking error signal TE (one of TE_A to TE_F) which is newly selected according to switching of Case at a switching timing of the above Case.

P(n)=Pₚᵣₑᵥ+D Case 1

P(n)=Pₚᵣₑᵥ−HPK+C Case 2

P(n)=Pₚᵣₑᵥ+C Case 3

P(n)=Pₚᵣₑᵥ−HPK+B Case 4

P(n)=Pₚᵣₑᵥ+B Case 5

P(n)=Pₚᵣₑᵥ−HPK+A Case 6

P(n)=Pₚᵣₑᵥ+A Case 7

P(n)=Pₚᵣₑᵥ−HPK+F Case 8

P(n)=Pₚᵣₑᵥ+F Case 9

P(n)=Pₚᵣₑᵥ−HPK+E Case 10

P(n)=Pₚᵣₑᵥ+E Case 11

P(n)=Pₚᵣₑᵥ−HPK+D Case 12

As can be seen from the calculation example by referring thereto, in the embodiment, the linear error signal is generated by sequentially connecting the tracking error signals TE for the pit strings adjacent in the movement direction of the spot position for each predetermined timing where the magnitude correlation of the amplitudes of the tracking error signals TE_A to TE_F having the respective phases is varied when the spot position is moved in the radius direction.

Specifically, in this example, the predetermined timings are put in a switching timing between Case 1 and Case 2, a switching timing between Case 3 and Case 4, a switching timing between Case 5 and Case 6, a switching timing between Case 7 and Case 8, a switching timing between Case 9 and Case 10, and a switching timing between Case 11 and Case 12, and, at the predetermined timings, the tracking error signals TE for the pit strings adjacent in the movement direction of the spot position are sequentially selected. Along therewith, by using a value obtained by subtracting the value (HPK) of the newly selected tracking error signal TE at the predetermined timing from the value (P_{prey})_{prey}) which is output as the linear error signal at the time point for each of the predetermined timings as a reference value (Pₚᵣₑᵥ−HPK), the value (P(n)) obtained by adding the value of the newly selected tracking error signal to the reference value is sequentially output as a value of the linear error signal.

The linear error signal can be generated by connecting the waveforms around the zero-cross points of the tracking error signals TE having the respective phases as shown in FIG. 18 in a state where the spot position is moved in the radius direction (both the outer circumferential direction and the inner circumferential direction) according to the method. In other words, even if a tracking error amount from a pit string where the servo is turned on is an error amount causing aliasing in the tracking error signals TE, a tracking error signal expressing the tracking error amount substantially linearly can be generated.

By generating such a linear error signal, in relation to a spot movement control of performing, for example, a track jumping operation or the like by using a movement amount or more causing aliasing in the tracking error signals TE as a target movement amount, for realization thereof, as a value of the offset to be given to the tracking servo loop in order to move the spot position to a target position, only a value corresponding to the target movement amount can be given.

In addition, as can be seen from the above-described calculation example by referring thereto, although the tracking error signals TE are sequentially switched to the tracking error signals TE for adjacent pit strings so as to be selected according to the movement of the spot position in this example as well, the selection and switching of the tracking error signals TE are performed based on a result of detecting varying points of the amplitude magnitude correlation of the respective tracking error signals TE, as the determination of Cases. In other words, a timing which is a middle point between the pit strings is detected based on a result of detecting the amplitudes of the tracking error signals TE in practice.

As such, by detecting a middle point timing between the pit strings as a timing where the tracking error signals TE are switched, based on the amplitudes of the practical tracking error signals TE, it is possible to suppress a difference amount between a value of the tracking error signal TE at the switching timing and the practical tracking error amount as compared with the related example of performing selection and switching of the tracking error signals TE based on a time length estimated from a slope of the offset, and thus stability of the tracking servo control can be further heightened.

In addition, as described above, as can be seen from the fact that the position control method in this example is a method in which the tracking error signal TE is sequentially switched to the tracking error signal TE for the adjacent pit string so as to be selected according to the movement of the spot position in a similar manner as the related example, the tracking servo control is continuously performed during the movement of the spot by the position control method in this example as well. That is to say, as can be seen therefrom, a movement of the spot position causing aliasing in an error signal in the related art can be realized through the closed-loop control by the position control method in this example as well.

### 2-3. Configuration of Spot Position Control Device According to Embodiment

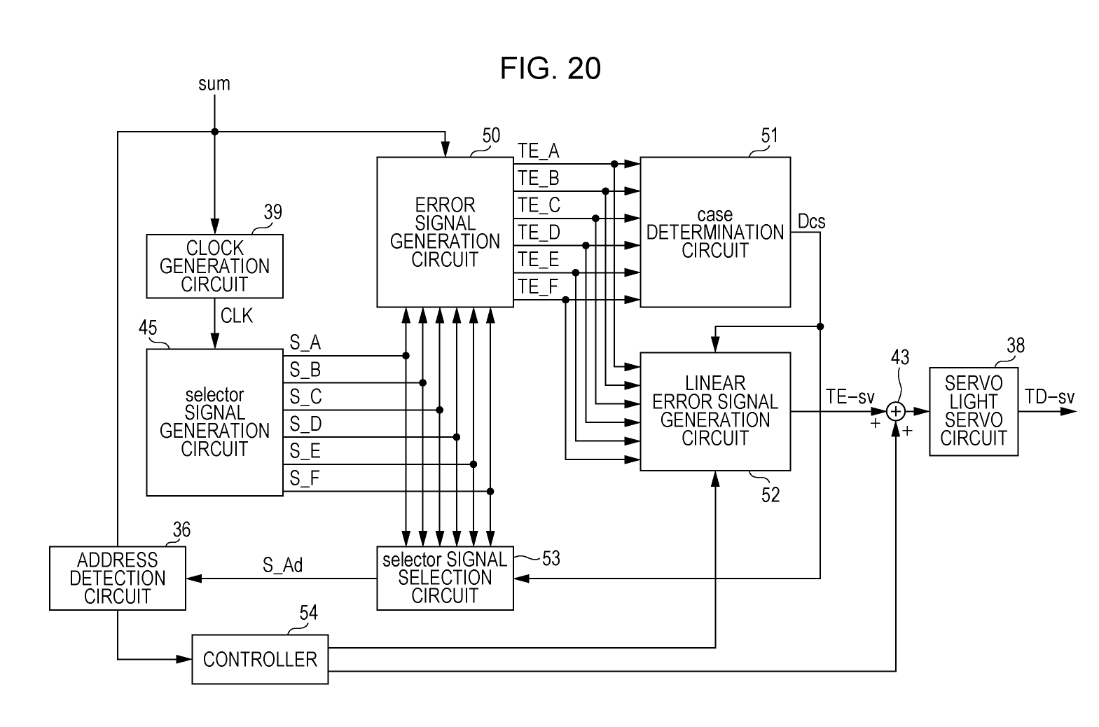

FIG. 20 is a diagram illustrating an internal configuration of the spot position control device according to the embodiment.

The spot position control device according to the embodiment is to change the configuration of the tracking servo control system for the servo laser light in the recording and reproduction device 10 according to the related example. For this reason, in FIG. 20, only a configuration of the tracking servo control system for the servo laser light included in the spot position control device according to the embodiment is extracted and is shown, and the configuration of the recording and reproduction system or the servo system in the optical pickup OP or the recording and reproduction laser light side is the same as the case of the recording and reproduction device 10, which thus is not shown.

In addition, in FIG. 20, the parts which have already been described in the related example are given the same reference numerals and description thereof will be omitted.

As can be seen through comparison of FIG. 20 with FIG. 13 (and FIG. 15), in the spot position control device according to the embodiment, the sample-and-hold circuits SH1 and SH2 which sample and hold the sum signal, and the subtractor 37 are omitted, and an error signal generation circuit 50 is provided. In addition, a Case determination circuit 51 and a linear error signal generation circuit 52 are newly provided.

Further, the spot position control device in this case includes a selector signal selection circuit 53 instead of the selector signal selection circuit 46 included in the recording and reproduction device 10 in the related example, and a controller 54 instead of the controller 41.

As shown in the figure, the selector signals (hereinafter, referred to as selector signals S_A to S_F) for the respective pit strings A to F, output from the selector signal generation circuit 45 are supplied to the error signal generation circuit 50 and the selector signal selection circuit 53.

The error signal generation circuit 50 generates tracking error signals TE (TE_A to TE_F) for the respective the pit strings A to F based on the selector signals S_A to S_F and a sum signal.

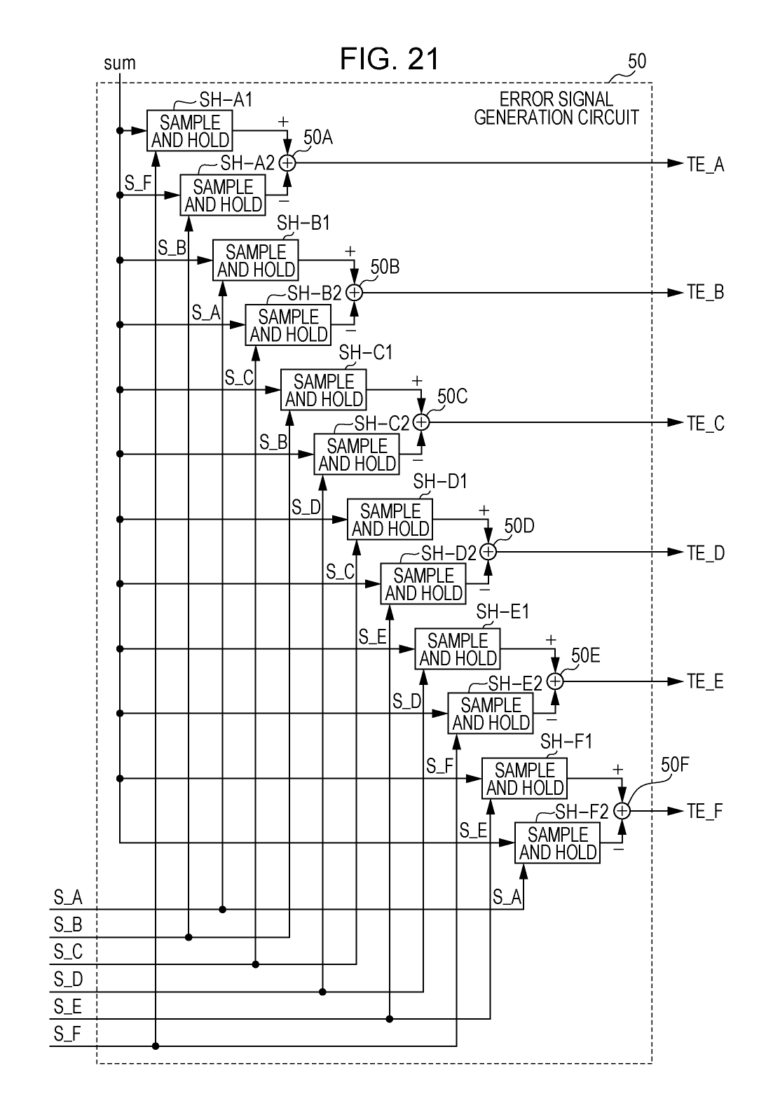

FIG. 21 shows an internal configuration of the error signal generation circuit 50.

As can be seen from FIG. 21 by referring thereto, in the error signal generation circuit 50, six error signal generation units each of which is formed by two sample-and-hold circuits and a subtractor are provided in parallel with respect to the sum signal in order to generate six error signals TE as the tracking error signals TE_A to TE_F.

Specifically, there are provided the error signal generation unit which generates the tracking error signal TE_A by a sample-and-hold circuit SH-A1 and a sample-and-hold circuit SH-A2 and a subtractor 50A, the error signal generation unit which generates the tracking error signal TE_B by a sample-and-hold circuit SH-B1 and a sample-and-hold circuit SH-B2 and a subtractor 50B, the error signal generation unit which generates the tracking error signal TE_C by a sample-and-hold circuit SH-C1 and a sample-and-hold circuit SH-C2 and a subtractor 50C, the error signal generation unit which generates the tracking error signal TE_D by a sample-and-hold circuit SH-D1 and a sample-and-hold circuit SH-D2 and a subtractor 50D, the error signal generation unit which generates the tracking error signal TE_E by a sample-and-hold circuit SH-E1 and a sample-and-hold circuit SH-E2 and a subtractor 50E, and the error signal generation unit which generates the tracking error signal TE_F by a sample-and-hold circuit SH-F1 and a sample-and-hold circuit SH-F2 and a subtractor 50F.

The sample-and-hold circuit SH-A1 samples and holds the sum signal at a timing indicated by the selector signal S_F, the sample-and-hold circuit SH-A2 samples and holds the sum signal at a timing indicated by the selector signal S_B, and the subtractor 50A subtracts the output from the sample-and-hold circuit SH-A2 from the output from the sample-and-hold circuit SH-A1, thereby generating the tracking error signal TE_A.

The sample-and-hold circuit SH-B1 samples and holds the sum signal at a timing indicated by the selector signal S_A, the sample-and-hold circuit SH-B2 samples and holds the sum signal at a timing indicated by the selector signal S_C, and the subtractor 50B subtracts the output from the sample-and-hold circuit SH-B2 from the output from the sample-and-hold circuit SH-B1, thereby generating the tracking error signal TE_B.

The sample-and-hold circuit SH-C1 samples and holds the sum signal at a timing indicated by the selector signal S_B, the sample-and-hold circuit SH-C2 samples and holds the sum signal at a timing indicated by the selector signal S_D, and the subtractor 50C subtracts the output from the sample-and-hold circuit SH-C2 from the output from the sample-and-hold circuit SH-C1, thereby generating the tracking error signal TE_C.

The sample-and-hold circuit SH-D1 samples and holds the sum signal at a timing indicated by the selector signal S_C, the sample-and-hold circuit SH-C2 samples and holds the sum signal at a timing indicated by the selector signal S_E, and the subtractor 50D subtracts the output from the sample-and-hold circuit SH-D2 from the output from the sample-and-hold circuit SH-D1, thereby generating the tracking error signal TE_D.

The sample-and-hold circuit SH-E1 samples and holds the sum signal at a timing indicated by the selector signal S_D, the sample-and-hold circuit SH-E2 samples and holds the sum signal at a timing indicated by the selector signal S_F, and the subtractor 50E subtracts the output from the sample-and-hold circuit SH-E2 from the output from the sample-and-hold circuit SH-E1, thereby generating the tracking error signal TE_E.

In addition, the sample-and-hold circuit SH-F1 samples and holds the sum signal at a timing indicated by the selector signal S_E, the sample-and-hold circuit SH-F2 samples and holds the sum signal at a timing indicated by the selector signal S_A, and the subtractor 50F subtracts the output from the sample-and-hold circuit SH-F2 from the output from the sample-and-hold circuit SH-F1, thereby generating the tracking error signal TE_F.

With reference to FIG. 20 again, the description will be made.

The tracking error signals TE_A to TE_F generated by the error signal generation circuit 50 are supplied to the Case determination circuit 51 and the linear error signal generation circuit 52.

The Case determination circuit 51 determines distinctions of Case 1 to Case 12 described above based on the tracking error signals TE_A to TE_F, and supplies a determination signal Dcs indicating the determined result to the linear error signal generation circuit 52 and the selector signal selection circuit 53.

Specifically, in this case, a switching timing of each Case is detected, and a signal indicating the switching timing of Case and a distinction of Case is generated and output as the determination signal Dcs.

The linear error signal generation circuit 52 generates the above-described linear error signal based on the tracking error signals TE_A to TE_F and the determination signal Dcs. Specifically, among the calculation equations for the respective Cases indicated by the above calculation example, a calculation is performed according to a calculation equation, indicated by the determination signal Dcs, corresponding to Case, and thereby the tracking error signal TE-sv is generated as the linear error signal.

In addition, the controller 53 sends a reset signal to the linear error signal generation circuit 52 at a timing where the tracking servo is turned on by the servo light servo circuit 38, and the linear error signal generation circuit 52 resets a value of the tracking error signal TE-sv as the linear error signal to 0 in response to the reset signal.

As shown in the figure, the tracking error signal TE-sv generated by the linear error signal generation circuit 52 is supplied to the adder 43.

The selector signal selection circuit 53 selects one selector signal as the selector signal S_Ad from the selector signals S_A to S_F supplied from the selector signal generation circuit 45 based on the determination signal Dcs, and outputs the selector signal S_Ad to the address detection circuit 36.

Specifically, at a predetermined timing among the respective switching timings for Case 1 to Case 12 indicated by the determination signal Dcs, the selector signal selection circuit 53 switches a selector signal S which is output as the selector signal S_Ad to a selector signal S adjacent to a selector signal S which has been output until the timing (that is, a selector signal S corresponding to a pit string adjacent to a pit string, in the movement direction of a spot, where the selector signal S having been output until the timing indicates a timing for a pit formable position). That is to say, in a case of this example, at a switching timing between Case 1 and Case 2, a switching timing between Case 3 and Case 4, a switching timing between Case 5 and Case 6, a switching timing between Case 7 and Case 8, a switching timing between Case 9 and Case 10, and a switching timing between Case 11 and Case 12, a selector signal S output as the selector signal S_Ad is switched to a selector signal S adjacent to a selector signal S which has been output until the timing.

The selector signal S_Ad selected by the selector signal selection circuit 53 is supplied to the address detection circuit 36, and thereby the address detection circuit 36 can appropriately detect address information recorded on a pit string around the spot position.

The controller 54 is constituted by the microcomputer in the same manner as the controller 41, and controls the overall device.

The controller 54 is different from the controller 41 in that an instruction for a selector signal using the selection signal SLCT is not performed but the following process is performed.

Specifically, the controller 54 in this case performs a control which is different from the case of the related example, as the seek operation control on the reference face Ref.

First, the controller 54 instructs “to move the optical pickup OP to the vicinity of a target address by moving the overall optical pickup OP using the above-described slide driving unit”, and “to turn on a focus servo for the servo laser light” in the same manner as the case of the related example, but, in this example, thereafter, the controller 54 instructs the linear error signal generation circuit 52 to select a predefined arbitrary tracking error signal TE from the tracking error signals TE_A to TE_F. That is to say, this performs the tracking servo control for an arbitrary pit string among the pit strings A to F.

When the tracking servo is performed for the arbitrary pit string in this way, although the controller 54 instructs the servo light servo circuit 38 to turn on a servo, the controller 54 performs the instruction for turning on a servo, and sends the above-described reset signal to the linear error signal generation circuit 52 so as to reset a value of the error signal TE-sv to 0.

As described above, by performing the tracking servo control for an arbitrary pit string, the selector signal selection circuit 53 selects a selector signal S (S_Ad) for a servo target pit string based on the determination signal Dcs from the Case determination circuit 51, and, in response thereto, the address detection circuit 36 detects address information recorded on the servo target pit string.

The controller 54 calculates a spot movement amount (target movement amount) necessary up to a target address based on the address information detected by the address detection circuit 36 in this way, and performs a control for realizing a jumping operation of moving the spot position by the target movement amount.

Specifically, the controller 54 gives an offset to the adder 43 at the time of entering a state where the spot position is moved in the radius direction by a target movement amount from a state of performing the tracking servo for a certain pit string, such as the track jumping operation performed during, for example, the seek operation, or the like. That is to say, the controller 54 outputs an offset signal of which a value gradually increases to a value corresponding to the target movement amount with the passage of time, to the adder 43. The offset signal in this case is not a saw-tooth wave signal unlike the related example, but is a linear offset signal.

According to the giving of the linear offset signal, the spot position is moved to a target position. At this time, as described above, the Case determination circuit 51 generates and outputs the determination signal Dcs and the linear error signal generation circuit 52 calculates an error signal (calculation causing sequential selection and switching of the tracking error signals TE_A to TE_F) in response to the determination signal Dcs, thereby generating a linear error signal indicating a tracking error amount or more, causing aliasing in the tracking error signal TE, substantially linearly. In addition, the tracking servo control is performed based on the linear error signal, and thereby a position control for realizing a spot movement by a movement amount or more causing aliasing in the error signal TE is realized through the closed-loop control.

### 3. Modified Example

As above, although the embodiment of the present disclosure has been described, the present disclosure is not limited to the detailed example described above.

For example, although a case where the tracking error signal TE is generated using a difference between the sample-and-hold values of the sum signal has been described as a countermeasure of skew or lens shift of the objective lens 20 in the above description, in a case where an influence by the skew or the lens shift can be disregarded, such as providing a correction unit of spot misalignment due to the skew or the lens shift, a signal obtained by sampling and holding a push-pull signal may be used as the tracking error signal TE.

In addition, although, in the above description, as shown in FIG. 18, a case where the tracking error signals TE_A to TE_F are used as they are in generation of a linear error signal has been described, a method of generating the linear error signal may use a method according to the following modified example.

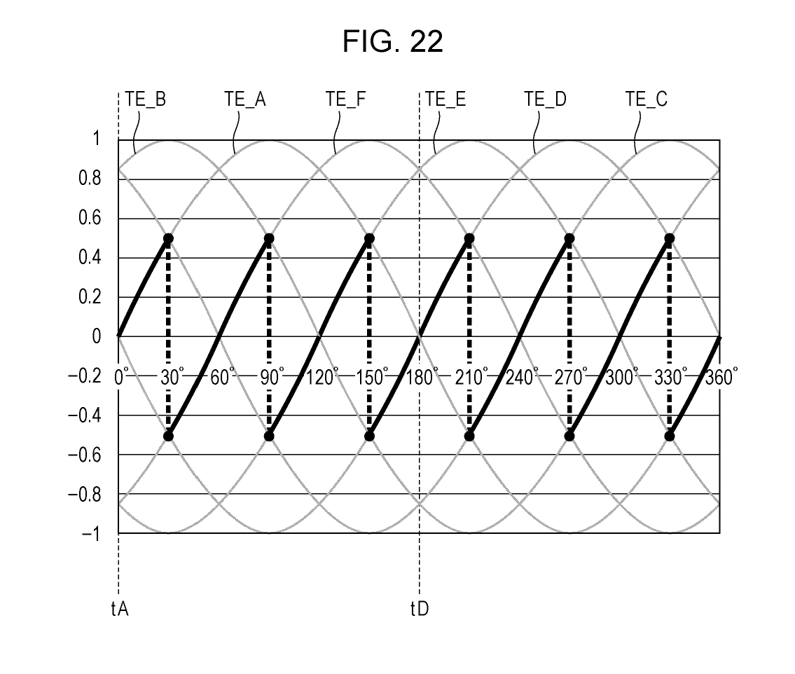

FIGS. 22 to 25 are diagrams illustrating a generation method of a linear error signal according to the modified example.

First, FIG. 22 shows waveforms of the tracking error signals TE_A to TE_F obtained when a spot position is moved in the radius direction, a time point to as a timing where the spot is located directly on the pit string A in the waveform diagram, and a time point tD as a timing where the spot is located directly on the pit string D.

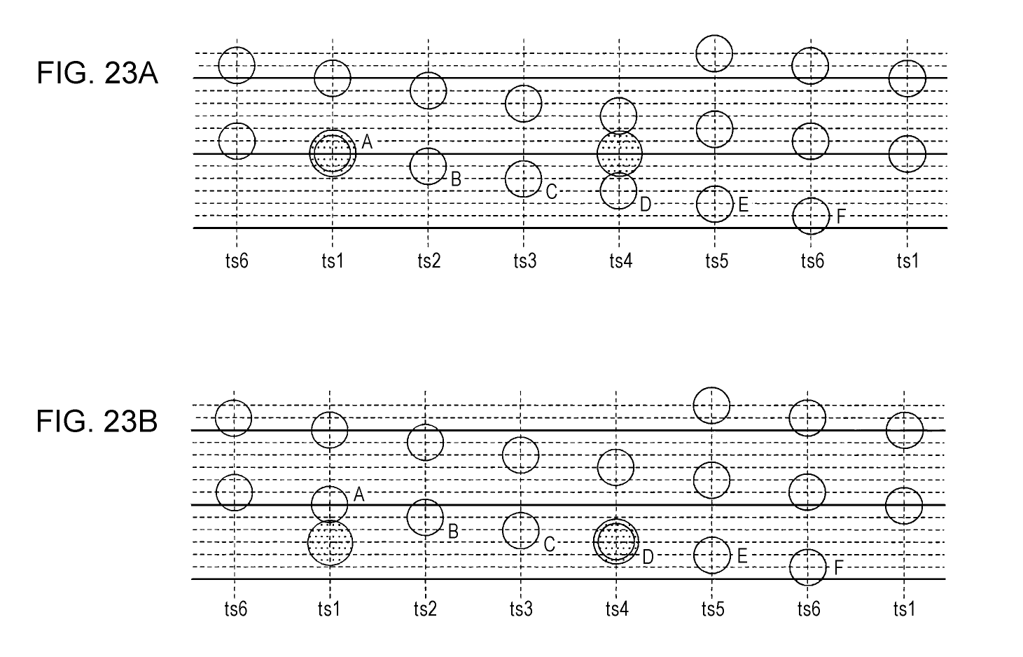

In addition, FIGS. 23A and 23B show a form where the spot traces the pit string A on the reference face Ref (FIG. 23A) and a form where the spot traces the pit string D (FIG. 23B).

Here, as shown in FIGS. 23A and 23B, a timing where the spot matches a pit formable position on the pit string A in the line direction (pit string formation direction) is set to ts1. In the similar manner, timings where the spot matches pit formable positions on the pit string B, the pit string C, the pit string D, the pit string E, and the pit string F, respectively, are set to ts2, ts3, ts4, ts5, and ts6 in the line direction.

First, referring to FIG. 22, it can be seen that the tracking error signal TE_A for the pit string A and the tracking error signal TE_D for the pit string D have a relationship of phases reverse to each other, that is, a relationship of polarities reverse to each other. That is to say, a relationship of A=−D can be obtained at all times.

The modified example is a method of using the sets of the tracking error signals TE having polarities reverse to each other among the tracking error signals TE_A to TE_F.

Here, the state where the spot shown in FIG. 23A traces the pit string A corresponds to the spot position at the time point tA when applied to FIG. 22. In a similar manner, the state where the spot shown in FIG. 23B traces the pit string D corresponds to the spot position at the time point tD in FIG. 22.

That is to say, as can be seen therefrom, according to the movement of the spot position in the radius direction, the spot position state shown in FIG. 23A is transitioned to the spot position state shown in FIG. 23B (or reverse transition).

In consideration thereof, at the time point tA shown in FIG. 22, in a state correspond to the state shown in FIG. 23A, the tracking error signal TE_A is generated based on reflection light of the spot which passes the targeted pit A directly thereon. However, when the spot position is moved in the radius direction and reaches the time point tD, that is, a state corresponding to the state shown in FIG. 23B, the tracking error signal TE_A is generated in a state where the spot is located at a position farthest from the targeted pit A.

In a similar manner, at the time point tD (a state corresponding to the state shown in FIG. 23B) shown in FIG. 22, the tracking error signal TE_D is generated based on reflection light of the spot which passes the targeted pit D directly thereon; however, at the time point to (a state corresponding to the state shown in FIG. 23A), the tracking error signal TE_D is generated in a state where the spot is located at a position farthest from the targeted pit D.

As such, under the circumstances where the spot is displaced in the radius direction, if the spot position becomes distant from the target pit string, the tracking error signals TE are generated based on reflection light of the spot which becomes distant from the target pit strings. Further, at this time, there is concern that, in the sections distant from the target pit strings, values thereof may have low reliability.

Here, in the relationship between the tracking error signals TE_A to TE_D, the tracking error signal TE_A places the spot position directly on the pit string D targeted by the tracking error signal TE_D at the time point tD where the spot position becomes most distant from the target pit string.

In consideration of this fact and the relationship of phases of the tracking error signal TE_A to TE_D reverse to each other (A=−D), in relation to the tracking error signal TE_A, if the tracking error signal TE_A is used as it is in a state where the spot is located around the targeted pit string A, and a reverse value of the tracking error signal TE_D is used in a state where the spot position becomes distant from the pit string A, resultantly, a signal having a waveform equivalent to the tracking error signal TE_A can be obtained at all times by a signal generated in a state where a spot is located around a target pit string.

This is also true of the tracking error signal TE_C to TE_E. That is to say, in relation to the tracking error signal TE_C, which forms a pair with the tracking error signal TE_F having the phase relationship reverse thereto, the tracking error signal TE_C is output as it is in a state where the spot is located around the targeted pit string C, and a reverse value of the tracking error signal TE_F is output in a state where the spot position becomes distant from the pit string C to an extent.

In addition, in relation to the tracking error signal TE_E, which forms a pair with the tracking error signal TE_B having the phase relationship reverse thereto, the tracking error signal TE_E is output as it is in a state where the spot is located around the targeted pit string E, and a reverse value of the tracking error signal TE_B is output in a state where the spot position becomes distant from the pit string E to an extent.

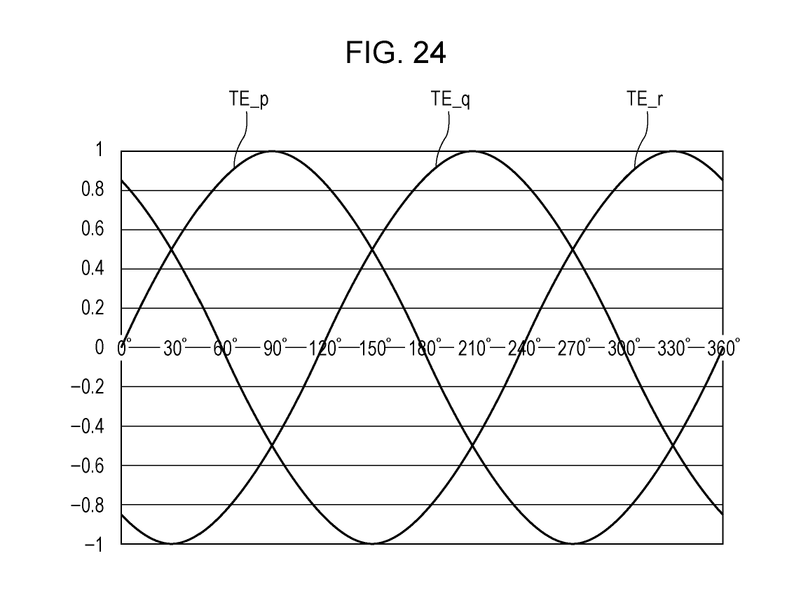

Here, the tracking error signals TE generated using the set of the tracking error signals TE_A and TE_D, the set of the tracking error signals TE_E and TE_B, and the set of the tracking error signals TE_C and TE_F are respectively set to tracking error signals TE_p, TE_q and TE_r. FIG. 24 shows waveforms thereof.

A detailed generation method of the tracking error signals TE_p, TE_q and TE_r will be described below.

In the following calculation equations, s1 to s6 denote amplitude values of the sum signal at the timings ts1 to ts6 shown in FIGS. 23A and 23B.

In addition, A denotes an amplitude value of the tracking error signal TE_A, and D denotes an amplitude value of the tracking error signal TE_D. In a similar manner, E, B, C, and F respectively denote amplitude values of the tracking error signals TE_E, TE_B, TE_C and TE_F.

s1<s4→TE_{—}p=A

s1≧s4→TE_{—}p=−D

s5<s2→TE_{—}q=E

s5≧s2→TE_{—}q=—B

s3<s6→TE_{—}r=C

s3≧s6→TE_{—}r=−F

In addition, a generation method of the tracking error signals TE_p, TE_q and TE_r is not limited to the above-described method, but, for example, may be performed as follows.

s6+s2<s3+s5→TE_{—}p=A

s6+s2≧s3+s5→TE_{—}p=−D

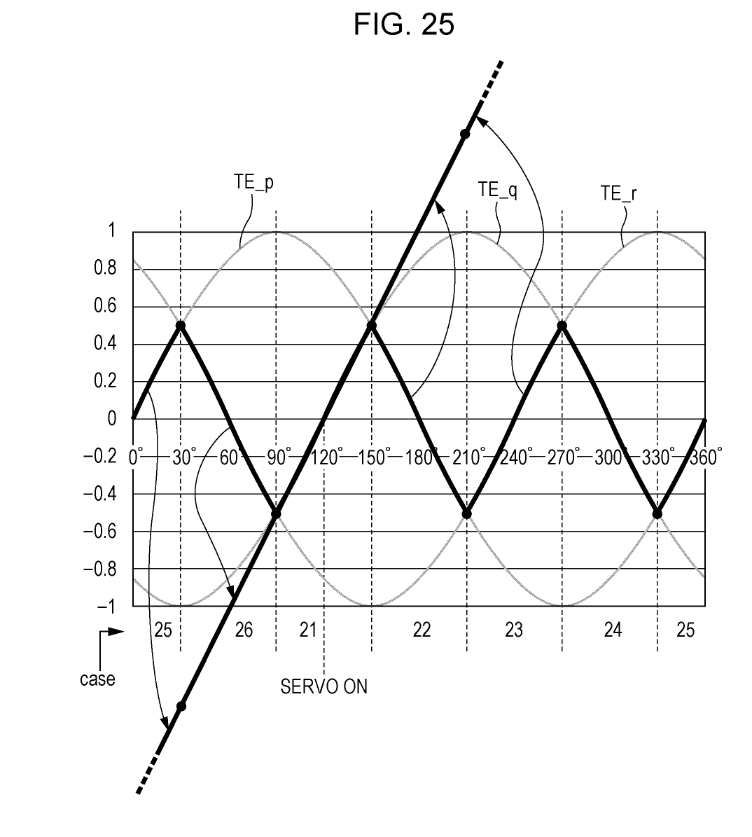

FIG. 25 is a diagram illustrating a detailed generation method of the linear error signal using the tracking error signals TE_p, TE_q and TE_r according to the modified example.

First, in this case as well, Case division is performed for each distinction of the amplitude magnitude correlation of each error signals TE. Specifically, phases of the error signals TE to be used are three, and thus Case may be divided into six Cases of Case 21 to Case 26.

If the amplitudes of the tracking error signals TE_p, TE_q and TE_r are respectively set to p, q and r, the definitions of Cases 21 to 26 are as follows.

p<q<r Case 21

q<p<r Case 22

q<r<p Case 23

r<q<p Case 24

r<p<q Case 25

p<r<q Case 26

In the modified example, the amplitudes of the respective tracking error signals TE_p, TE_q and TE_r are sequentially monitored, and the respective Cases defined as described above are determined. In addition, each Case determined in this way is calculated as described below, thereby generating the linear error signal.

In addition, the following calculation example is based on the premise of a case where a pit string where the servo is initially turned on is the pit string E, and a state where a spot is located on the pit string E is set to a zero point of the linear error signal.

In the following calculation example, the definitions of P(n), Pₚᵣₑᵥ, and HPK are the same as in the embodiment.

P(n)=Pₚᵣₑᵥ+q Case 21

P(n)=Pₚᵣₑᵥ−HPK−p Case 22

P(n)=Pₚᵣₑᵥ−HPK+r Case 23

P(n)=Pₚᵣₑᵥ−HPK−q Case 24

P(n)=Pₚᵣₑᵥ−HPK+p Case 25

P(n)=Pₚᵣₑᵥ−HPK−r Case 26

In this way, in the linear error signal generation method according to the modified example as well, the linear error signal is generated by sequentially connecting the tracking error signals TE for the pit strings adjacent in the movement direction of the spot position for each predetermined timing where the magnitude correlation of the amplitudes of the tracking error signals TE having the respective phases is varied when the spot position is moved in the radius direction.

Specifically, in the modified example, each time the magnitude correlation of the amplitudes of the tracking error signals TE having the respective phases is varied when the spot position is moved in the radius direction, the tracking error signals TE (TE_q targets the pit string E, TE_r targets the pit string C, and the TE_p targets the pit string A) for pit strings adjacent in the movement direction of the spot position are sequentially selected. Along therewith, by using a value obtained by subtracting the value (HPK) of the newly selected tracking error signal TE at the predetermined timing from the value (Pₚᵣₑᵥ) which is output as the linear error signal at the time point for each timing (the predetermined timing) where the magnitude correlation of the amplitudes is varied as a reference value (Pₚᵣₑᵥ−HPK), the value (P(n)) obtained by adding the value of the newly selected tracking error signal TE to the reference value is sequentially output as a value of the linear error signal.

In addition, in relation to the generation method of the linear error signal according to the modified example, upon comparison of FIG. 25 with FIG. 18, it can be seen that the tracking error signal TE_q selected as Case 21 corresponds to the tracking error signal TE_E, and tracking error signal TE_q selected as Case 24 corresponds to the tracking error signal TE_B. In addition, it can be seen that tracking error signal TE_p selected as Case 22 corresponds to the tracking error signal TE_D, tracking error signal TE_p selected as Case 25 corresponds to the tracking error signal TE_A, tracking error signal TE_r selected as Case 23 corresponds to the tracking error signal TE_C, and the tracking error signal TE_r selected as Case 26 corresponds to the tracking error signal TE_F.

As can be seen therefrom, the linear error signal generation method according to the modified example is also a method of connecting the waveforms around the zero-cross point of the tracking error signal TE_A to TE_F respectively corresponding to the pit strings A to F having the respective phases, formed on the reference face Ref.

According to the error signal generation method according to the modified example described above, in a case of using a signal obtained by sampling and holding the push-pull signal as the tracking error signal TE, the sampled and held signal can be used as the tracking error signal TE in a state where a spot is located at a position closer to a target pit string, and thus it is possible to obtain a tracking error signal TE having higher reliability even in a case where parts having no pits occur due to address modulation.

Although, in the above description, the track jumping operation has been described as an example of an operation of moving a spot position in the radius direction, the present disclosure is appropriately applicable to a position control for moving a spot position of servo laser light in a spiral shape with an arbitrary pitch by giving an offset.

In a case of performing such a spiral control, it is preferable to give an offset having a slope corresponding to a pitch desired to be realized, as an offset given to the servo loop.

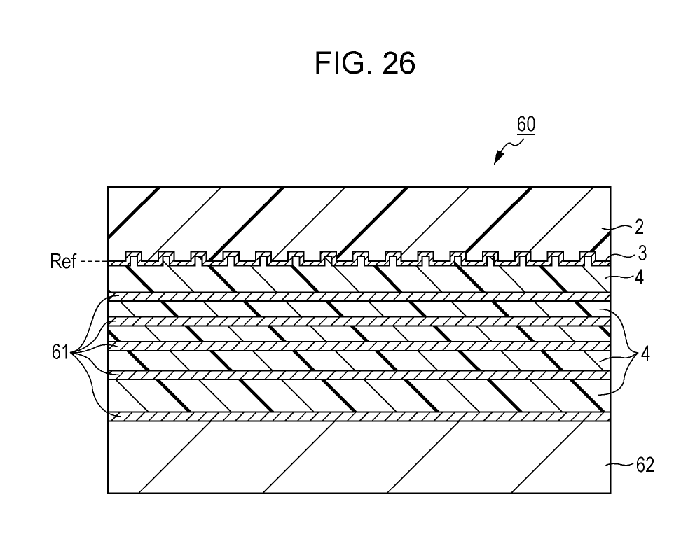

In addition, although, in the above description, a case where an optical recording medium which is a recording target is the bulk type optical recording medium in the present disclosure has been described, the present disclosure is appropriately applicable to, for example, an optical recording medium (multi-layer recording medium 60) which is provided with a recording layer having a multi-layer structure on which a plurality of recording films are formed, as shown in FIG. 26, instead of the bulk layer 5.

In FIG. 26, the multi-layer recording medium 60 is the same as the bulk type recording medium 1 shown in FIG. 2 in that the cover layer 2, the selective reflection film 3, and the intermediate layer 4 are sequentially formed from the upper layer side; however, in this case, instead of the bulk layer 5, a recording layer having a layer structure where a translucent recording film 61 and the intermediate layer 4 are repeatedly laminated a predetermined number of times as shown in the figure. As shown in the figure, the translucent recording film 61 formed on the bottom layer is laminated on the substrate 62. In addition, a total reflection recording film may be used as the recording film formed on the bottom layer.

Here, it is noted that position guiders accompanied by the formation of pit strings are not formed on the translucent recording film 61. That is to say, even in the multi-layer recording medium 60, position guiders having a spiral shape or a concentric shape are formed only on one layer position as the reference face Ref.

The translucent recording film 61 which functions as a reflection film is formed in the recording layer of the multi-layer recording medium 60, and thus a focus control using reflection light of recording and reproduction laser light can be performed during recording as well.

That is to say, during the recording in this case, a focus servo control for the recording and reproduction laser light is performed such that the translucent recording film 61 which is a recording target is focused by driving the movable lens 15 (the lens driving unit 16) based on reflection light of the recording and reproduction laser light.

In addition, detailed methods of a focus servo and a tracking servo during reproduction may be similar to the case targeting the bulk type recording medium 1.

Further, although, in the above description, the reference face on which the pit strings are formed is provided on the upper layer side of the recording layer, the reference face may be provided on the lower layer side of the recording layer.

In addition, although, in the above description, a configuration in which the light source of laser light for recording on the recording layer and the light source of laser light for performing information reproduction, or tracking and focus servos using light reflected from the mark strings recorded on the recording layer are used in common has been described, the light source for recording and the light source for information reproduction and servo control may be provided separately from each other.

Although not described hitherto, in this example, the pit strings are recorded on the reference face Ref by a CAV method, and, in order to correspond thereto, the bulk type recording medium 1 is rotatably driven at a constant rotation velocity, and thus recording density is sparse in the outer circumferential side of the recording layer. As a countermeasure thereof, a configuration for making the recording density constant (or a state regarded as being constant), such as, for example, continuously varying recording clock frequencies according to a radius position, may be added.

Further, although, in the above description, a case where the pit string is formed on the reference face Ref in a spiral shape has been described, the pit string may be formed in a concentric shape. In a case where the pit string is formed in a concentric shape as well, generation of a linear error signal or a position control method using it may be the same as that described above.

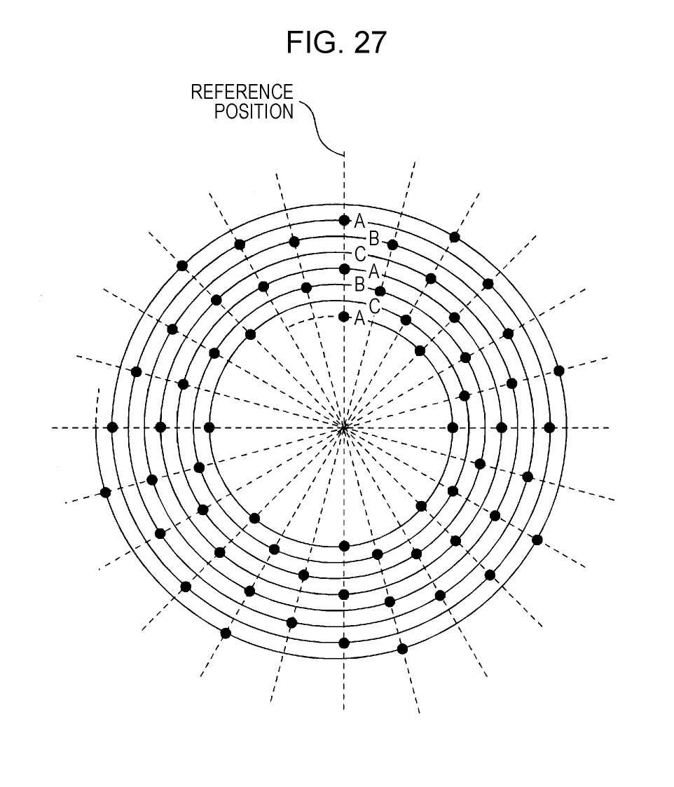

Although, in the above description, a case where the pit strings A to F having the respective phases are formed spirally independently from each other has been described, as shown in FIG. 6, as an example of the case where the pit strings are formed in a spiral shape, the pit strings may be formed as one spiral as shown in FIG. 27 (single spiral structure). In addition, for convenience of illustration in FIG. 27 as well, phases of the pit strings show only three of A to C.

As shown in the figure, a specific rotation angular position on the disc is set as a reference position, and phases of the pit strings are sequentially varied for each round defined using the reference position as a reference. For example, in a format where the pit strings A, B, C, . . . are arranged from the outer circumferential side to the inner circumferential side as shown in FIG. 5 (that is, the phase of the pit string gradually increases toward the outer circumferential side), the pit strings are formed such that the phases of the pit strings gradually lead for each round in a state where the n-th round is a phase of the pit string A, the (n+1)-th round is a phase of the pit string C, the (n+2)-th round is a phase of the pit string B, . . . , as shown in the figure.

As can be seen through comparison with FIG. 6, the phase relationship between the respective pit strings arranged in the radius direction can be the same as the case in FIG. 6 by such a single spiral structure as well.

Here, when a disc having the multi-spiral structure as shown in FIG. 6 is created, there may be a method in which the respective pit strings A to F are cut individually on the same stamper; however, in this case, the respective pit strings are sequentially cut while slightly shifting the start position in the radius direction, and thereby there is concern that there may be difficulty in terms of accuracy.

In contrast, in the single spiral structure as shown in FIG. 27, the number of cutting is only one, and if formation timings of pits are accurately controlled, technical difficulty can be considerably reduced in terms of the accuracy.

In addition, in the single spiral structure as shown in FIG. 27, a tracking servo targeting a certain pit string may not be continuously performed during one round or more. Therefore, in this case, recording on the recording layer is performed in a spiral shape with a predetermined pitch by giving an offset signal having a predetermined slope to the tracking servo loop.

Further, although, in the above description, a total of six pit strings A to F are set as a plurality of pit strings having different pit string phases and the pit strings are repeatedly formed by the six patterns (pit string phases) in the radius direction, the number of the plurality of pit strings is not limited to six, but may be more than that or less than that.

In addition, although a case where the section length of each pit formable position on the pit string is 3 T, and the interval between edges of the pit formable positions in the pit string formation direction is set to the length of the same 3 T (that is, n is set to 6 T) has been described, this is only an example. The section length of each pit formable position and the interval between the edges of the pit formable positions in the pit string formation direction may be set so as to satisfy the above conditions 1) and 2).

Although, in the above description, in relation to a plurality of pit strings having different pit string phases, the pit strings are arranged such that the pit string phase leads toward the outer circumferential side and lags toward the inner circumferential side, for example, reversely, the pit strings may be arranged such that the pit string phase lags toward the outer circumferential side and leads toward the inner circumferential side. As such, arrangement patterns of the plurality of pit strings may be set as a variety of patterns under the condition of not exceeding the optical limit in the pit string formation direction.

Further, although, in the above description, a case where the present disclosure is applied to the recording and reproduction device which performs both of recording and reproduction for the optical recording medium (recording layer) has been described, the present disclosure is also appropriately applicable to a recording only device (recording device) which can perform only recording for the optical recording medium (recording layer).

The present disclosure contains subject matter related to that disclosed in Japanese Priority Patent Application JP 2010-251574 filed in the Japan Patent Office on Nov. 10, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. A spot position control device comprising:
a light irradiation and light sensing unit configured to irradiate an optical recording medium with first light via an objective lens and sense reflection light of the first light from the optical recording medium having a pit string, wherein an interval between pit formable positions on one round is limited to a first interval and which is formed in a spiral shape or a concentric shape and is arranged in a radius direction, wherein the interval between the pit formable positions in a pit string formation direction is set to be misaligned by a predetermined second interval such that the optical recording medium has a plurality of pit string phases;
a tracking mechanism unit configured to displace the objective lens in the radius direction;
a clock generation unit configured to generate a clock corresponding to the interval between the pit formable positions based at least in part on a light sensing signal obtained by the light irradiation and light sensing unit by sensing reflection light of the first light;
a timing selector signal generation unit configured to generate a plurality of timing selector signals, which respectively indicate timings for the pit formable positions on the pit strings having the respective phases, formed on the optical recording medium, based at least in part on the clock generated by the clock generation unit;
a tracking error signal generation unit configured to generate a plurality of tracking error signals, which respectively indicate tracking errors in the pit strings having the respective phases, formed on the optical recording medium, based at least in part on the light sensing signal for the reflection light of the first light and the timing selector signals generated by the timing selector signal generation unit;
a linear tracking error signal generation unit configured to generate a linear tracking error signal indicating a tracking error amount linearly, by sequentially connecting signals in sections around zero-cross points of the plurality of tracking error signals obtained when an irradiation spot of the first light is moved in the radius direction;
a tracking servo control unit configured to perform a tracking servo control for the objective lens by driving the tracking mechanism unit based at least in part on the linear tracking error signal; and
an offset giving unit configured to give an offset for moving the irradiation spot in the radius direction to a tracking servo loop formed by the tracking servo control by the tracking servo control unit.

2. The spot position control device according to claim 1, wherein the linear tracking error signal generation unit is configured to generate the linear tracking error signal by sequentially connecting tracking error signals for pit strings adjacent in a movement direction of the irradiation spot for each predetermined timing where a magnitude correlation of the amplitudes of the plurality of tracking error signals is varied.

3. The spot position control device according to claim 2, wherein the linear tracking error signal generation unit is configured to sequentially select tracking error signals for pit strings adjacent in the movement direction of the irradiation spot for each predetermined timing, and, at the predetermined timing, by using a value obtained by subtracting a value of a newly selected tracking error signal at the predetermined timing from a value which has been output as the linear tracking error signal at a time point, as a reference value, sequentially outputs a value obtained by adding a value of the newly selected tracking error signal to the reference value, as a value of the linear tracking error signal.

4. The spot position control device according to claim 2, wherein position information is recorded on the optical recording medium for each pit string depending on whether a pit is formed at the pit formable position on each pit string, and
wherein the spot position control device further includes:
a timing selector signal selection unit configured to select timing selector signals for the pit strings adjacent in the movement direction of the irradiation spot from the plurality of timing selector signals for each predetermined timing where the magnitude correlation of the amplitudes of the plurality of tracking error signals is varied; and
a position information detection unit configured to detect the position information based at least in part on a result of sampling a value of the light sensing signal at a timing indicated by a timing selector signal selected by the timing selector signal selection unit and determining a channel bit value indicating whether a pit is formed at the pit formable position.

5. The spot position control device according to claim 1, wherein the tracking error signal generation unit is configured to sample and hold values of the light sensing signal at timings indicated by the timing selector signals corresponding to the respective pit strings having a same phase difference relationship for each of the pit strings having the respective phases, and calculates a difference between the values, thereby generating the tracking error signal for each of the pit strings having the respective phases.

6. The spot position control device according to claim 1, wherein the optical recording medium includes a reference face on which the pit string is formed, and a recording layer formed at a depth position different from the reference face, and
wherein the light irradiation and light sensing unit is configured to irradiate the optical recording medium with second light used to perform recording on the recording layer along with the first light via the objective lens.

7. The spot position control device according to claim 6, wherein the light irradiation and light sensing unit is configured to irradiate the optical recording medium having a recording layer in a bulk state as the recording layer, with the first light and the second light.

8. The spot position control device according to claim 6, wherein the light irradiation and light sensing unit is configured to irradiate the optical recording medium having a recording layer which has a multi-layer structure where recording films are formed at a plurality of positions in the depth direction, as the recording layer, with the first light and the second light.

9. A spot position control method in a spot position control device including a light irradiation and light sensing unit is configured to irradiate an optical recording medium with first light via an objective lens and sense reflection light of the first light from the optical recording medium having a pit string, wherein an interval between pit formable positions on one round is limited to a first interval and which is formed in a spiral shape or a concentric shape and is arranged in a radius direction, wherein the interval between the pit formable positions in a pit string formation direction is set to be misaligned by a predetermined second interval such that the optical recording medium has a plurality of pit string phases, and a tracking mechanism unit configured to displace the objective lens in the radius direction, the method comprising:
generating a clock corresponding to the interval between the pit formable positions based at least in part on a light sensing signal obtained by the light irradiation and light sensing unit sensing reflection light of the first light;
generating a plurality of timing selector signals, which respectively indicate timings for the pit formable positions on the pit strings having the respective phases, formed on the optical recording medium, based at least in part on the clock generated in the generating of the clock;
generating a plurality of tracking error signals, which respectively indicate tracking errors in the pit strings having the respective phases, formed on the optical recording medium, based at least in part on the light sensing signal for the reflection light of the first light and the timing selector signals generated in the generating of the timing selector signal;
generating a linear tracking error signal indicating a tracking error amount linearly, by sequentially connecting signals in sections around zero-cross points of the plurality of tracking error signals obtained when an irradiation spot of the first light is moved in the radius direction; and
performing tracking servo control for the objective lens by driving a tracking mechanism based at least in part on the linear tracking error signal, and giving an offset for moving the irradiation spot in the radius direction to a tracking servo loop formed by performing the tracking servo control.
